(19) United States
(12) Patent Application Publication
(10) Pub. No.: US 2011/0225520 A1
(43) Pub. Date: Sep. 15, 2011

(54) WEBSITE BROWSING SYSTEM AND SERVER

(75) Inventor: Kentaro WATANABE, Tokyo (JP)

(73) Assignee: FUJIFILM CORPORATION, Tokyo (JP)

(21) Appl. No.: 13/016,807

(22) Filed: Jan. 28, 2011

(30) Foreign Application Priority Data
Mar. 10, 2010 (JP) JP2010-053256

(51) Int. Cl. G06F 3/01; G06F 15/16

(52) U.S. Cl. 715/760

(57) ABSTRACT

A server includes: a receiving device configured to acquire page contents requested by a predetermined client terminal among multiple client terminals; multiple information generation devices each of which includes a conversion device configured to convert the acquired page contents to an image and a UI information metadata generating device configured to extract UI information from the acquired page contents and to generate UI information metadata on the basis of the extracted UI information; a session management device configured to, upon receiving the request from the predetermined client terminal, issue a session ID for identifying the predetermined client terminal and to manage the issued session ID and a desired information generation device among the multiple information generation devices in association with each other; and a transmission device configured to transmit the converted image, the generated UI information metadata and the issued session ID to the predetermined client terminal.

### BACKGROUND OF THE INVENTION

1. Field of the Invention

The presently disclosed subject matter relates to a website browsing system and a server, and in particular to a website browsing system for browsing and operating a website for PCs (personal computers) on such a client terminal that the screen size and the downloadable file size are restricted, such as a mobile phone, and a server.

2. Description of the Related Art

Recently, there are a lot of occasions of browsing a website by a mobile phone. However, since it costs much and is very troublesome to create a website for mobile phones in addition to a website for PCs, a site creator has a tendency to avoid creation of a website for mobile phones. Therefore, it is often the case that a site for mobile phones is not prepared at a website which a user wants to browse.

In the case of browsing a website for PCs on a mobile phone inferior to a PC in the image size and the downloadable file size, it is conceivable to receive a contents file being divided and display the contents file as multiple pages. However, when browsing the webpage on a PC and browsing the webpage on a mobile phone are compared, difference in appearance occurs.

Conversion to a markup language for mobile phones is also conceivable. However, a design deformation problem tends to occur.

To cope with this problem, there is proposed a method of converting a website for PCs to an image to display it on a mobile phone. For example, in Japan Patent Application Laid-Open No. 2004-220260, a webpage is constructed of components of an HTML (HyperText Markup Language) document or the like of a webpage acquired on an image distribution server, and the created webpage is converted to bitmap image data or the like and transmitted to a client terminal. When the user of the client terminal on which this image data is displayed clicks a displayed character string or the like using a pointing device, the client terminal transmits coordinates data of the clicked position and the URL of the displayed webpage to the image distribution server. The image distribution server checks whether or not a link pointer corresponding to the transmitted click position coordinates exists on the basis of the components of the webpage, and accesses a web server specified by a URL indicated by the link pointer if the link pointer exists.

According to the technique of Japan Patent Application Laid-Open No. 2004-220260, it is possible even for a client terminal which is not implemented with a web browser to browse a webpage.

### SUMMARY OF THE INVENTION

In the technique described in Japan Patent Application Laid-Open No. 2004-220260, it is possible to utilize a link pointer (a link tag in HTML) in a webpage and display a link destination corresponding to a position clicked by a user. However, input forms other than link tags, such as a text input field and a checkbox, may not be utilized. Thus, in Japan Patent Application Laid-Open No. 2004-220260, there is a problem that all user interface (UI) information in an webpage may not be utilized.

Furthermore, since communication with a server is performed each time a user operation occurs, there is a problem that the load on the server is high, and furthermore, there is a problem that much communication time is required.

The presently disclosed subject matter has been made in view of the above situation, and its object is to provide a website browsing system making it possible to browse and operate different webpages for PCs using multiple mobile phones or the like, and a server.

In order to achieve the above object, a first aspect of the presently disclosed subject matter provides A website browsing system in which multiple client terminals connect to a server, wherein the server includes: a first receiving device configured to acquire page contents requested by a predetermined client terminal among the multiple client terminals; multiple information generation devices each of which includes a conversion device configured to convert the acquired page contents to an image and a UI information metadata generating device configured to extract UI information from the acquired page contents and to generate UI information metadata on the basis of the extracted UI information; a session management device configured to, upon receiving the request from the predetermined client terminal, issue a session ID for identifying the predetermined client terminal and to manage the issued session ID and a desired information generation device among the multiple information generation devices in association with each other; and a first transmission device configured to transmit the converted image, the generated UI information metadata and the issued session ID to the predetermined client terminal, and the client terminal includes: a second transmission device configured to request desired page contents from the server; a second receiving device configured to receive the image of the requested page contents, the UI information metadata and the session ID which have been transmitted from the server; a display device configured to display the image on the basis of the received image and UI information metadata; and a display control device configured to display the received image on the display device and to display the UI information on the image on the basis of the UI information metadata.

According to the first aspect, when page contents are requested by a predetermined client terminal among multiple client terminals, a session ID for identifying the predetermined client terminal is issued, and the session ID and a desired information generation device among multiple information generation devices are managed in association with each other. The page contents acquired by the predetermined information generation device associated with the session ID is converted to an image, and UI information metadata is generated. The image, the UI information metadata and the session ID are transmitted to the client terminal. The client terminal which receives them displays the image on the display device and displays UI information on the image on the basis of the UI information metadata. Thereby, it is possible to browse and operate a webpage for PCs at a high speed using a mobile phone or the like without deforming the design of the webpages. Furthermore, it is possible to enable each of multiple client terminals to browse and operate a webpage corresponding to the request of the client terminal.

A second aspect of the presently disclosed subject matter provides a website browsing system according to the first aspect, wherein, when the first receiving device receives a request from a client terminal other than the predetermined client terminal, among the multiple client terminals, the session management device generates a session ID for identifying the client terminal other than the predetermined client terminal, which is a session ID different from the session ID for identifying the predetermined client terminal, and manages the generated session ID and an information generation device which is not associated with a session ID among the multiple information generation devices in association with each other.

According to the second aspect, when a request from a client terminal other than a predetermined client terminal is received, a session ID for identifying the client terminal other than the predetermined client terminal, which is a session ID different from a session ID for identifying the predetermined client terminal is generated. Then, the generated session ID and an information generation device which is not associated with a session ID yet are managed in association with each other. Thereby, it is possible to perform different processing for a request from a different client terminal.

A third aspect of the presently disclosed subject matter provides a website browsing system according to the first or second aspect, wherein the second transmission device transmits information indicating the client terminal to the server; the first receiving device receives the information indicating the client terminal; and the session management device determines whether or not the client terminal is a mobile terminal on the basis of the information indicating the client terminal, and does not generate a session ID if it is determined that the client terminal is not a mobile terminal.

According to the third aspect, information indicating a client terminal is received from the client terminal, and it is determined whether or not the client terminal is a mobile terminal on the basis of this information. A session ID is not issued if the client terminal is not a mobile terminal, and a session ID is issued if the client terminal is a mobile terminal. Therefore, it is possible to generate an image or UI information when generation of the image or the UI information is necessary.

A fourth aspect of the presently disclosed subject matter provides a website browsing system according to the first or second aspect, wherein the client terminal further includes a user ID storage device in which information indicating a client terminal and a user ID are stored in association with each other, the second transmission device transmits the information indicating the client terminal to the server, the first receiving device receives the information indicating the client terminal, and the session management device determines whether or not the received information indicating the client terminal is stored in the user ID storage device, and generates a session ID if it is determined that the information is stored in the user ID storage device.

According to the fourth aspect, information indicating a client terminal and a user ID are stored in association with each other. A session ID is generated if information indicating a client terminal transmitted from the client terminal is stored. Thereby, it is possible to provide an authentication function for the website browsing system.

A fifth aspect of the presently disclosed subject matter provides a website browsing system according to any of the first to fourth aspects, wherein the client terminal includes: an execution device configured to execute the UI information on the image displayed on the display device; and a rewriting device configured to rewrite the UI information metadata on the basis of the UI information executed by the execution device, and wherein the second transmission device transmits the rewritten UI information metadata to the server together with the session ID, the first receiving device receives the rewritten UI information metadata which has been transmitted from the client terminal together with the session ID, the information generation device associated with the received session ID rewrites the image on the basis of the received UI information metadata, and the first transmission device transmits the rewritten image to the client terminal together with the session ID.

According to the fifth aspect, when UI information on an image displayed on a client terminal is executed, UI information metadata is rewritten and transmitted to a server together with a session ID. An information generation device associated with the session ID rewrites the image on the basis of the UI information metadata, and the rewritten image is transmitted to the client terminal together with the session ID. Thereby, it is possible to display an image according to an operation of executed UI information. Furthermore, since UI information metadata is transmitted together with a session ID, it is possible to certainly recognize on which client terminal the operation has been performed and prevent the image from being wrongly transmitted to a different client terminal.

A sixth aspect of the presently disclosed subject matter provides a website browsing system according to the fifth aspect, wherein, if the UI information executed by the execution device is UI information accompanied by screen transition, the second transmission device transmits information identifying the UI information to the server together with the session ID, the first receiving device receives the information identifying the UI information and the session ID which have been transmitted from the second transmission device, the information generation device associated with the received session ID generates an image of page contents to be displayed next and UI information metadata of the page contents on the basis of the received information, and the first transmission device transmits the image of the page contents to be displayed next and the UI information metadata of the page contents which have been generated, to the client terminal.

According to the sixth aspect, when UI information accompanied by screen transition is executed, information identifying the UI information is transmitted to the server together with a session ID. An information generation device associated with the session ID generates an image of page contents to be displayed next and UI information metadata of the page contents on the basis of the information identifying the UI information, and the generated image and UI information metadata are transmitted to the client terminal with a session ID. Thereby, it is possible to, when UI information accompanied by screen transition is executed, appropriately display an image to be displayed next. Furthermore, since information identifying UI information is transmitted together with a session ID, it is possible to certainly recognize on which client terminal the operation has been performed and prevent the image from being wrongly transmitted to a different client terminal.

A seventh aspect of the presently disclosed subject matter provides a website browsing system according to the fifth or sixth aspect, wherein the execution device further includes: a movement device configured relatively to move a cursor and an image displayed on the display device; and a decision device configured to decide UI information existing at a position overlapping a position of the cursor as UI information to be executed.

Thereby, it is possible to appropriately select UI information to be executed.

An eighth aspect of the presently disclosed subject matter provides a website browsing system according to the seventh aspect, wherein the movement device moves the cursor relative to the image displayed on the display device.

Thereby, it is possible to appropriately select UI information to be executed.

A ninth aspect of the presently disclosed subject matter provides a website browsing system according to the seventh aspect, wherein the movement device displays the cursor almost in the center of the display device and moves the image relative to the cursor.

Thereby, it is possible to appropriately select UI information to be executed.

A tenth aspect of the presently disclosed subject matter provides a website browsing system according to any of the first to ninth aspects, wherein the movement device displays a visual effect on the basis of the UI information metadata.

Therefore, it is possible to improve the operability.

An eleventh aspect of the presently disclosed subject matter provides a website browsing system according to any of the first to tenth aspects, wherein the server includes a storage device in which page contents are stored; and the first receiving device configured to acquire page contents acquires the page contents from the storage device.

Thereby, communication with an external apparatus is not required to acquire a contents file, and it is possible to realize high-speed and user-friendly webpage browsing.

A twelfth aspect of the presently disclosed subject matter provides a website browsing system according to any of the first to eleventh aspects, wherein the server includes a connecting device configured to connect to a web server; and the first receiving device configured to acquire page contents acquires the page contents from the web server via the connecting device configured to connect to the web server.

Thereby, it is possible to browse various webpages. Furthermore, it is possible to browse a contents file which is not stored in the server.

A thirteenth aspect of the presently disclosed subject matter provides a server constituting the website browsing system according to any of the first to twelfth aspects.

According to the presently disclosed subject matter, it is possible to browse and operate different webpages for PCs using multiple mobile phones and the like without deforming the design of the webpages.

### BRIEF DESCRIPTION OF THE DRAWINGS

FIG. 1 is a diagram illustrating that a webpage for PCs is browsed on a display section 2 of a PC 1 and a display section 14 of a mobile terminal 10;

FIG. 2 is a diagram illustrating an example of the whole configuration of a webpage browsing system 100;

FIG. 3A is a flowchart illustrating an operation performed before a desired webpage is displayed on the display section 14 of the mobile terminal 10 in the webpage browsing system 100, and FIG. 3B is a flowchart illustrating an operation performed until a desired webpage is displayed on a display section 24 of a PC 20 in the webpage browsing system 100;

FIGS. 4A, 4B and 4C are diagrams for illustrating generation of UI metadata;

FIG. 5 is a diagram illustrating metadata stored as a CSV (comma separated value) file;

FIGS. 6A and 6B are flowcharts illustrating an internal process of the mobile terminal 10 in the webpage browsing system 100;

FIGS. 7A and 7B are diagrams illustrating the case where a cursor moves in response to an operation;

FIGS. 8A and 8B are diagrams illustrating the case where an image moves in response to an operation;

FIG. 9 is a diagram illustrating enlargement and reduction of an image displayed on the display section 14;

FIGS. 10A, 10B, 10C and 10D are diagrams for illustrating rewriting of UI metadata;

FIGS. 11A, 11B, and 11C are diagrams for illustrating rewriting of UI metadata;

FIG. 12 is a flowchart illustrating an operation performed when a UI operation is performed on the mobile terminal 10 in the webpage browsing system 100;

FIG. 13 is a diagram illustrating an example of the whole configuration of a webpage browsing system 101;

FIG. 14 is a flowchart illustrating an operation performed before a desired webpage is displayed on the display section 14 of the mobile terminal 10 in the webpage browsing system 101;

FIG. 15 is a flowchart illustrating an operation performed when a UI operation is performed on the mobile terminal 10 in the webpage browsing system 101;

FIGS. 16A and 16B are flowcharts illustrating an internal process of the mobile terminal 10;

FIGS. 17A and 17B are flowcharts illustrating an internal process of the mobile terminal 10; and

FIG. 18 is a diagram illustrating that the cursor is attracted to UI information.

### DETAILED DESCRIPTION OF THE PREFERRED EMBODIMENTS

Embodiments for practicing the presently disclosed subject matter will be described below with reference to accompanying drawings.

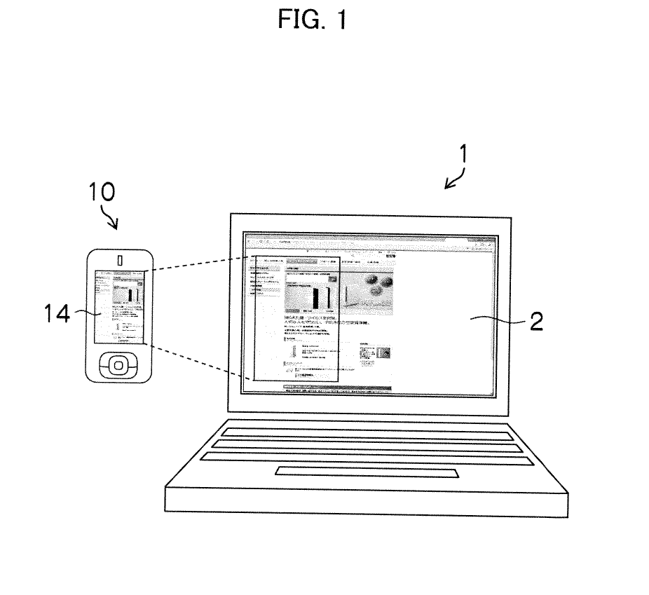

FIG. 1 is a diagram illustrating an image of browsing a webpage using a display section 14 of a mobile terminal 10 just like browsing the webpage using a display section 2 of a PC 1. As illustrated in FIG. 1, the mobile phone according to the presently disclosed subject matter is capable of browsing a webpage similarly to a PC.

### First embodiment

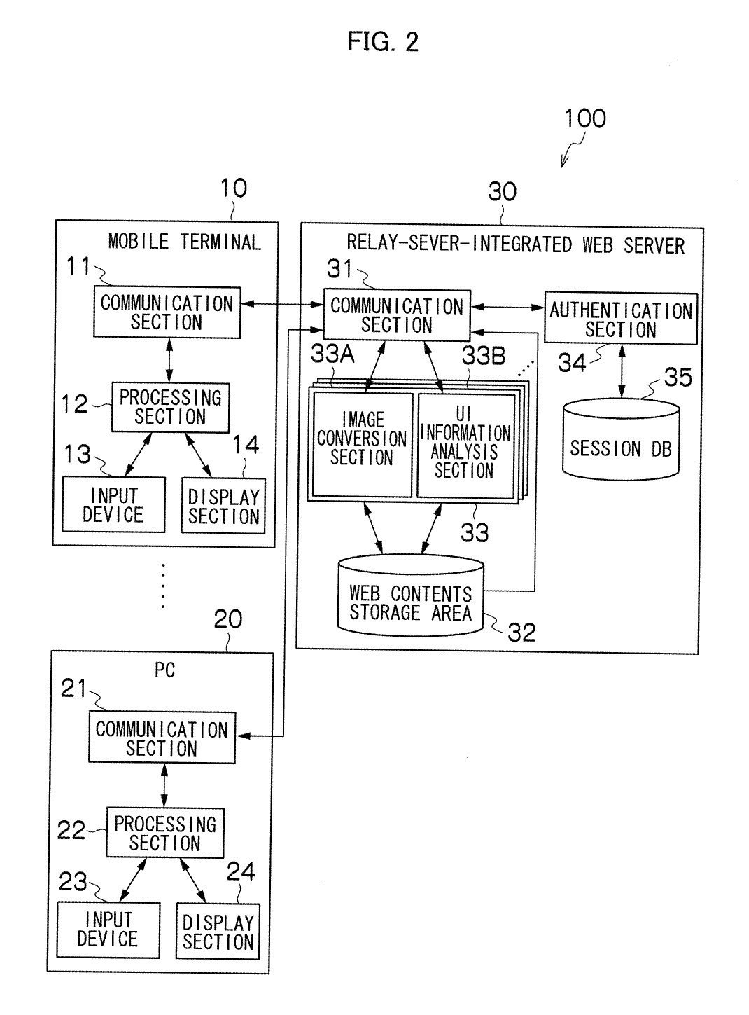

FIG. 2 is a diagram illustrating an example of the whole configuration of a webpage browsing system 100 in this embodiment. As illustrated in FIG. 2, the webpage browsing system 100 includes multiple mobile terminals 10 and multiple PCs 20 used by users, and an integrated web server (hereinafter referred to as an integrated server) 30 which includes the function of a relay server for communicating with the mobile terminals 10 and the PCs 20 to perform relay between the mobiles terminals 10 and PCs 20 and a web server and the function of a web server.

The mobile terminal 10 includes a communication section 11, a processing section 12, an input device 13 and a display section 14.

The communication section 11 controls communication with the integrated server 30 by predetermined protocols.

The mobile terminal 10 and the integrated server 30 are connected via the so-called Internet, and each of the communication section 11 and a communication section 31 to be described later performs communication in accordance with standard Internet protocols such as TCP/IP (Transmission Control Protocol/Internet Protocol). They may be connected via a dedicated communication line or a VPN (Virtual Private Network).

The processing section 12 causes an image acquired from the integrated server 30 via the communication section 11 to be displayed on the display section 14, and performs processing based on an input operation via the input device 13 by a user.

The input device 13 includes a power source button, number keys, a cross key, a decision key and the like (not illustrated), and the user can operate the mobile terminal 10 by operating the input device 13. A touch panel may be arranged on the front surface of the display section 14 to be used as the input device 13.

The display section 14 is a liquid crystal display capable of color display, and performs display on the basis of an image signal inputted from the processing section 12. A display device of another type, such as an organic EL (electroluminescence) display, may be used.

The PC 20 includes a communication section 21, a processing section 22, an input device 23 and a display section 24. The PC 20 is such that is already well known. Since the functions of the sections constituting the PC 20 are similar to those of the mobile terminal 10, description thereof will be omitted.

The integrated server 30 includes a communication section 31, a web contents storage area 32, multiple information-for-mobile-terminal generation sections 33 (each of which includes an image conversion section 33A and a UI information analysis section 33B), an authentication section 34 and a session DB (database) 35. The communication section 31 controls communication with the mobile terminal 10.

The web contents storage area 32 stores a contents file of each webpage.

There exist the same number of information-for-mobile-terminal generation sections 33 as the number of session IDs issued by the authentication section 34 to be described later. The information-for-mobile-terminal generation section 33 includes the image conversion section 33A and the UI information analysis section 33B.

On the basis of page contents (a contents file), the image conversion section 33A generates an image file similarly to the state at the time when the contents file is browsed. Here, the image file is generated with a predetermined resolution. However, an image file with a resolution corresponding to the contents of the contents file or corresponding to the resolution of the mobile terminal 10 may be generated.

The UI information analysis section 33B analyzes the contents file and extracts UI information. The UI information analysis section 33B extracts the UI information from the contents file and analyzes the kind and the position to generate UI metadata.

The authentication section 34 determines which of a mobile terminal 10 and a PC 20 the counterpart connected to the communication section 31 is. When a mobile terminal 10 or a PC 20 starts communication with the communication section 31 (at the time of access), information indicating the mobile terminal 10 is sent from the mobile terminal 10, and information indicating the PC 20 is sent from the PC 20. Therefore, the authentication section 34 can make the determination on the basis of the information. As an example of the information indicating the mobile terminal 10 and the information indicating the PC 20, a user agent is given.

If it is determined that the counterpart connected to the communication section 31 is a mobile terminal 10, the authentication section 34 issues a session ID. Then, the authentication section 34 associates one of the multiple information-for-mobile-terminal generation sections 33 with the issued session ID and stores information about the association into the session DB 35 to perform session management. Thereby, separate communication can be made with each of the multiple mobile terminals 10.

If the mobile terminal 10 does not access for a predetermined time or more after the session ID is issued, the authentication section 34 ends the session and deletes the data about the session ID stored in the session DB 35. Thereby, it becomes possible to issue the session ID when another mobile terminal 10 or the like accesses.

It was described that the integrated server 30 of this embodiment has multiple information-for-mobile-terminal generation sections 33. This concept includes the case where there are multiple information-for-mobile-terminal generation sections 33, the case where there is one information-for-mobile-terminal generation section 33 in which each of the image conversion section 33A and the UI information analysis section 33B is divided in multiple areas, and the like. In the case where there are multiple information-for-mobile-terminal generation sections 33, an information-for-mobile-terminal generation section 33 is associated with a session ID. In the case where each of one image conversion section 33A and one UI information analysis section 33B is divided in multiple areas, one predetermined area of the image conversion section 33A and one predetermined area of the UI information analysis section 33B are associated with a session ID.

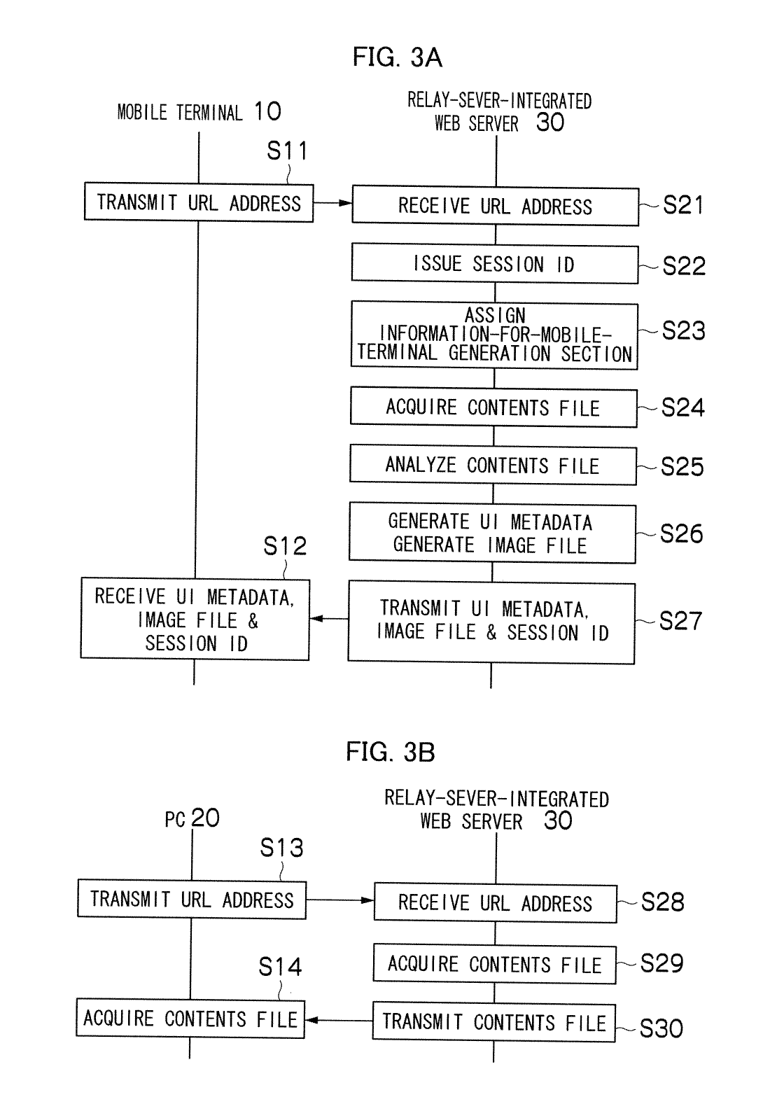

Next, the operation of the webpage browsing system 100 configured as described above will be described. First, the operation performed before a desired webpage is displayed on the display section 14 of the mobile terminal 10 will be described with reference to FIG. 3A.

A user inputs the URL (Uniform Resource Locator) address of a webpage which he wants to browse, using the input device 13 of the mobile terminal 10. A URL address may be selected with the use of a bookmark or the like registered with a storage section (not illustrated) of the mobile terminal 10 instead of directly inputting a character string. When the user instructs transmission by a transmission button of the input device 13 after inputting the URL address, the communication section 11 transmits the inputted URL address to the integrated server 30 (step S11).

It is also possible to hold webpage titles and URL addresses as bookmarks in a storage section (not illustrated) of the integrated server 30 so that a webpage title can be selected from among the webpage titles. In this case, the integrated server 30 transmits the webpage titles which it holds to the mobile terminal 10 via the communication section 31, and the mobile terminal 10 receives them via the communication section 11. Furthermore, the received webpage titles are displayed on the display section 14 by the processing section 12. The user selects a desired webpage from among the displayed webpage titles using the input device 13. Then, the mobile terminal 10 can transmit the selected webpage title to the integrated server 30 via the communication section 11.

At step S11, the mobile terminal 10 transmits information indicating the mobile terminal 10 to the integrated server 30 together with the URL address. The information indicating the mobile terminal 10 is a user agent here, which is information including information indicating a carrier (“Carrier 1”, “ Carrier 2”, “ Carrier 3” and the like) and information indicating the model of the mobile terminal 10 (hereinafter referred to as a model name).

The integrated server 30 receives the URL address and the user agent transmitted from the mobile terminal 10 via the communication section 31 (step S21). The authentication section 34 receives the user agent via the communication section 31. The authentication section 34 analyzes the user agent, and issues a session ID if it recognizes that the access is from the mobile terminal 10 (step S22). Then, a desired one of the multiple information-for-mobile-terminal generation sections 33 (hereinafter referred to as an information-for-mobile-terminal generation section 33−1) is assigned to the session ID, and the session ID, the information-for-mobile-terminal generation section 33−1 and the user agent are stored into the session DB in association with one another (step S23).

An image conversion section (hereinafter referred to as an image conversion section 33A−1) of the information-for-mobile-terminal generation section 33−1 acquires a contents file, such as an HTML file, a CSS (cascading style sheets) file and a Java Script file, corresponding to the received URL address from the web contents storage area 32 (step S24).

A UI information analysis section (hereinafter referred to as a UI information analysis section 33B−1) of the information-for-mobile-terminal generation section 33−1 acquires the same contents file as the image conversion section 33A−1 has acquired, from the web contents storage area 32, and it analyzes the acquired contents file and extracts UI information (step S25). The contents file analysis method here is not especially limited, and a well-known method, such as a method of extracting a tag by parsing, may be used.

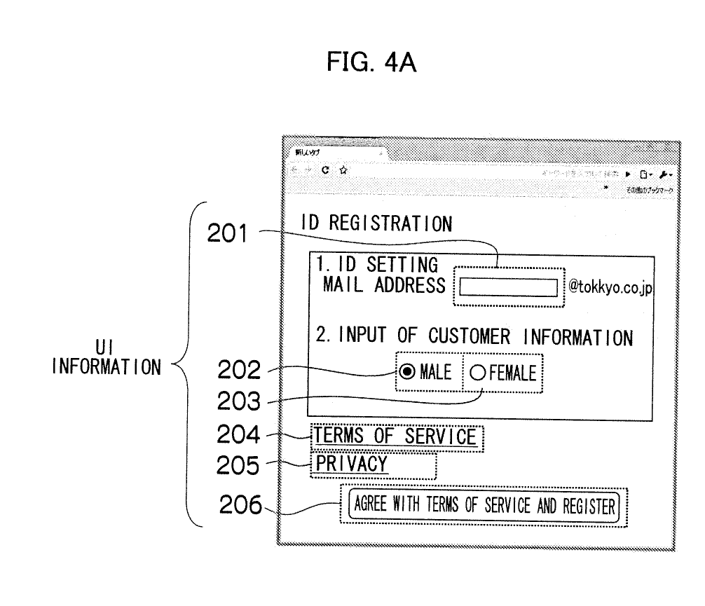

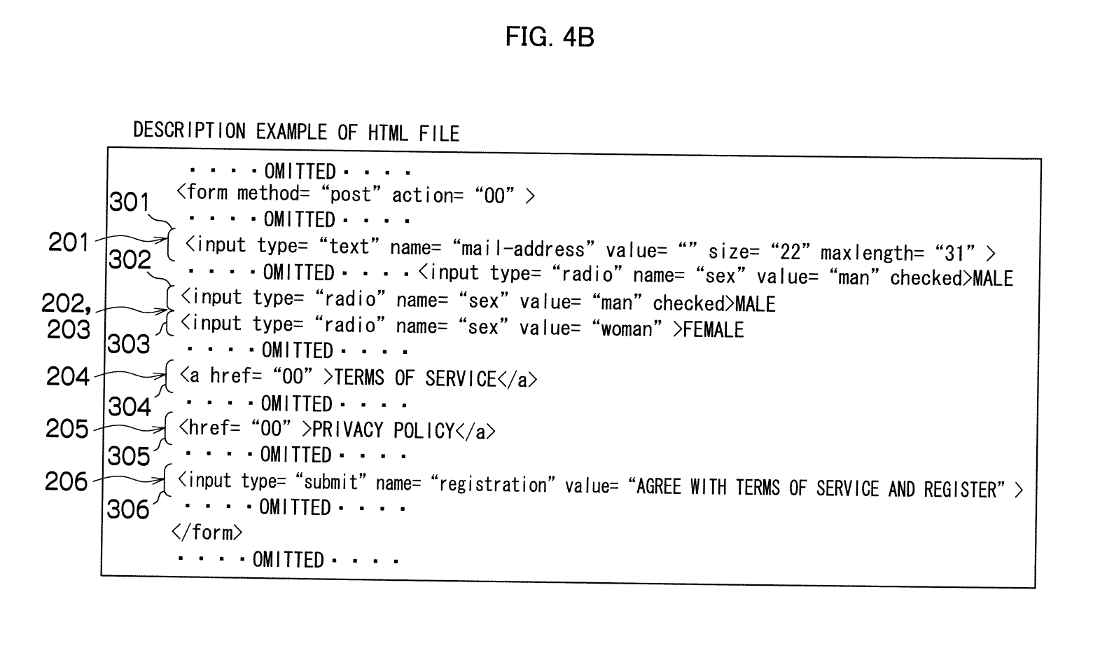

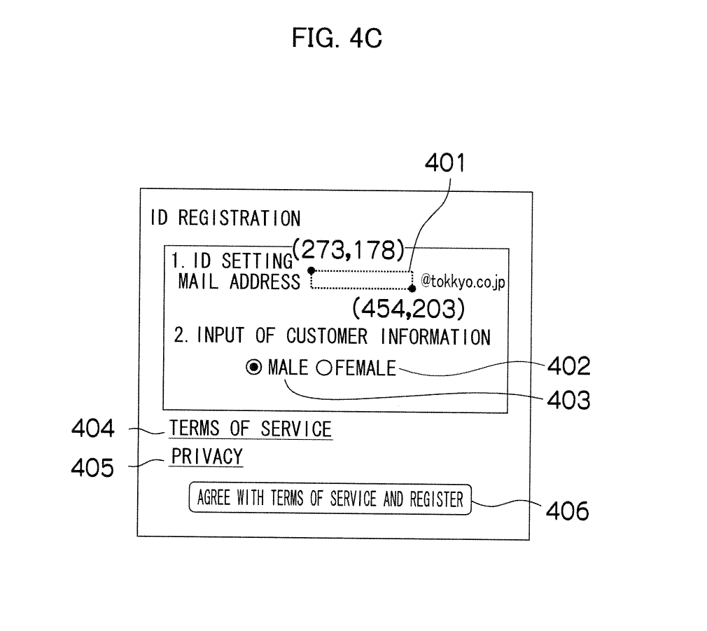

The UI information analysis section 33B generates UI metadata on the basis of the result of this analysis (step S26). FIGS. 4A, 4B and 4C are diagrams for illustrating of generation of the UI metadata. FIG. 4A is a diagram illustrating the state in which the HTML file illustrated in FIG. 4B has been browsed with the use of a PC or the like. In the HTML file illustrated in FIG. 4B, unnecessary parts are appropriately omitted.

The UI information analysis section 33B−1 extracts UI information such as a link tag and an input form, from the HTML file illustrated in FIG. 4B and calculates position coordinates in FIG. 4A of each UI information.

For example, in the HTML file illustrated in FIG. 4B, six tags, that is, a text input field tag 301, a radio button tag 302, a radio button tag 303, a link tag 304, a link tag 305 and a button tag 306 are illustrated. The UI information analysis section 33B extracts pieces of UI information 201 to 206 by extracting these tags from the HTML file.

The pieces of UI information 201 to 206 are arranged on positions on the screen illustrated in FIG. 4A in a state that the HTML is browsed. The UI information analysis section 33B−1 acquires XY coordinate values (coordinate values corresponding to the upper left and the lower right) indicating the start and end of these pieces of UI information. The coordinate value acquisition method is not especially limited. For example, methods such as storage during image rendering and acquisition from a browser may be used.

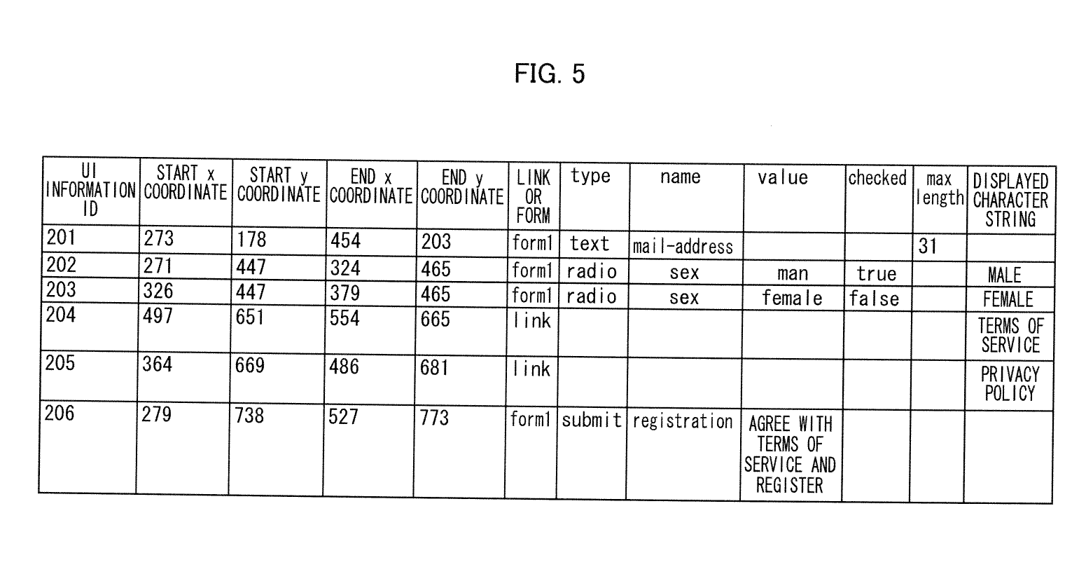

Each of the pieces of UI information and the position information about it which have been extracted as described above are associated with each other together with each UI information ID and stored into the session DB 35 as UI metadata in association with a session ID. Here, the UI information IDs are assumed to be 201 to 206. FIG. 5 is a diagram illustrating the UI metadata stored as a CSV file. Attributes (for example, a size attribute) related to screen display, such as layout, need not be included in the UI metadata.

The image conversion section 33A−1 performs rendering of the acquired contents file and generates an image file in a format which can be displayed on the display section 14 of the mobile terminal 10, such as a JPEG (Joint Photographic Experts Group) format and a bitmap format (step S26). The image file generation method is not limited. The image file generation can be performed in a well-known method.

FIG. 4C is a diagram illustrating an image obtained by performing rendering of the HTML file illustrated in FIG. 4B. Here, by using the UI metadata illustrated in FIG. 5, the positions and classifications of pieces of UI information in this image can be known. For example, it is seen that pieces of UI information corresponding to the tags 301 to 306 are arranged at positions 401 to 406 illustrated in FIG. 4C. The arrangement of these positions is similar to the arrangement of the pieces of UI information 201 to 206 in the browsed state illustrated in FIG. 4A. This image file may be stored in the storage section (not illustrated) of the integrated server 30 together with the UI metadata.

The integrated server 30 transmits the UI metadata and image file generated at step S26 and the session ID issued at step S22 to the mobile terminal 10 via the communication section 31 (step S27). At this time, the basis contents file is stored into the session DB 35 in association with the transmission-destination mobile terminal 10, the generated UI metadata, the image file and a session ID.

The mobile terminal 10 receives the UI metadata, the image file and the session ID via the communication section 11 (step S12).

When a URL address is transmitted to the integrated server 30 from a different mobile terminal 10 in this state (step S 11), the authentication section 34 of the integrated server 30 receives it (step S21), and issues a session ID different from the session ID already issued (step S22). The authentication section 34 assigns an information-for-mobile-terminal generation section 33 (for example, an information-for-mobile-terminal generation section 33−2) from among the multiple information-for-mobile-terminal generation sections 33 to the session ID (step S23) and stores it into the session DB 35 in association with the session ID. Thereby, a different session ID is assigned to each mobile terminal 10 which communicates with the integrated server 30. As for the processing at steps S24 to S12, description will be omitted.

On the other hand, in the case of access from the PC 20, a session ID is not issued. FIG. 3B is a flowchart illustrating an operation performed before a desired webpage is displayed on the display section 24 of the PC 20.

When a user inputs the URL address of a webpage which he wants to browse, using the input device 23 of the PC 20, the URL address and information indicating the PC 20 are transmitted to the integrated server 30 via the communication section 21 (step S13). The information indicating the PC 20 is a user agent here, and it includes information indicating a web browser (a character string including, for example, Mozilla or Opera).

The integrated server 30 receives this via the communication section 31 (step S28). The authentication section 34 receives the user agent via the communication section 31. The authentication section 34 analyzes the user agent. When it recognizes that the access is from the PC 20, and acquires a contents file, such as an HTML file, a CSS file and a Java Script file, corresponding to the received URL address, from the web contents storage area 32 (step S29).

The integrated server 30 transmits the contents file acquired at step S29 to the PC 20 via the communication section 31 (step S30). The PC 20 receives the UI metadata, the image file and the session ID via the communication section 11 (step S14). In the case of the PC 20, it is not necessary to generate UI metadata and an image file because web contents can be immediately browsed by a web browser. Therefore, it is not necessary to issue a session ID. Since the subsequent display process is the same as a well-known process, description thereof will be omitted.

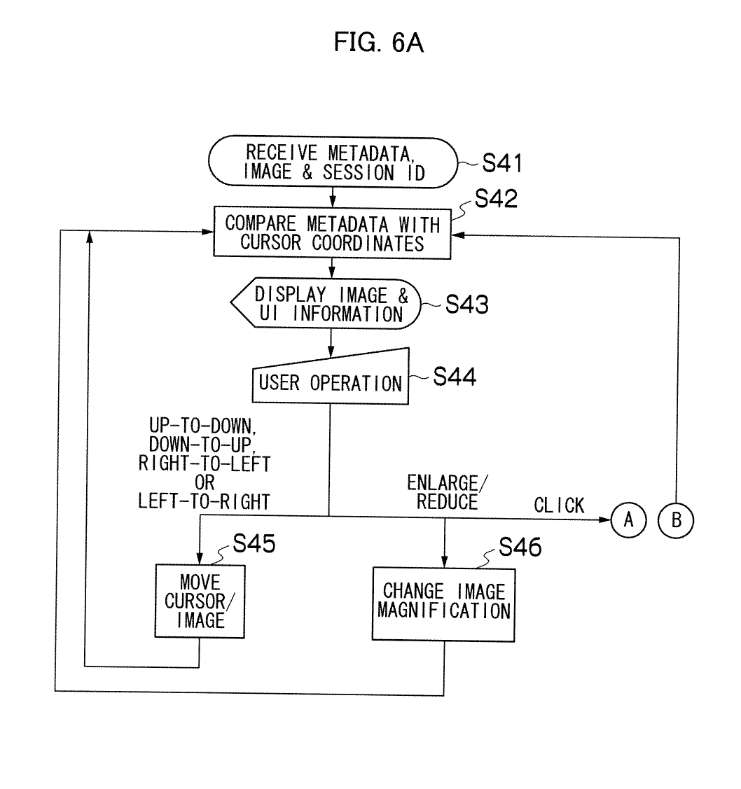

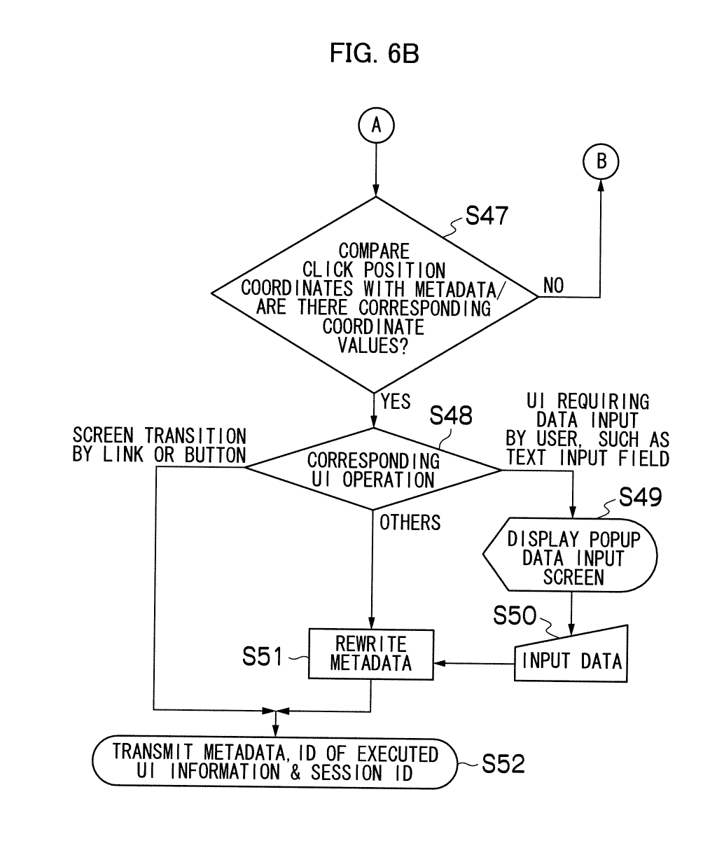

Next, an internal process of the mobile terminal 10 which has received the UI metadata and the image file will be described with reference to FIGS. 6A and 6B.

When the mobile terminal 10 receives the UI metadata, the image file and the session ID via the communication section 11 (step S41), the processing section 12 compares the position coordinates of each of pieces of UI information included in the received UI metadata and the position coordinates of a cursor displayed on the display section 14 (step S42), and displays the image file and the pieces of UI information on the display section 14 on the basis of the result of the comparison (step S43).

For example, when the position coordinates of the cursor overlaps with the position coordinates of a piece of UI information, a mark is attached to the position of the piece of UI information to make the user recognize that the piece of UI information is selectable. The position may be underlined or surrounded by a square. Here, when the cursor is positioned in a rectangular range with the XY coordinate values of a piece of UI information recorded in the UI metadata as diagonal corners, the position coordinates of the piece of UI information and the position coordinates of the cursor are considered to overlap with each other. Such a mark may be always illustrated at the position of a displayed piece of UI information on an image, instead of being illustrated in the case where the position coordinates overlap. On the contrary, when the position coordinates of the cursor overlaps with the position coordinates of a piece of UI information, the cursor may be displayed with its color or shape changed.

Here, when a user operation is performed via the input device 13 (step S44), display of the display section 14 is changed according to the contents of the operation.

For example, when an up-to-down, down-to-up, right-to-left or left-to-right movement operation by the cross key or the like is performed, the cursor or the image is moved according to the operation (step S45).

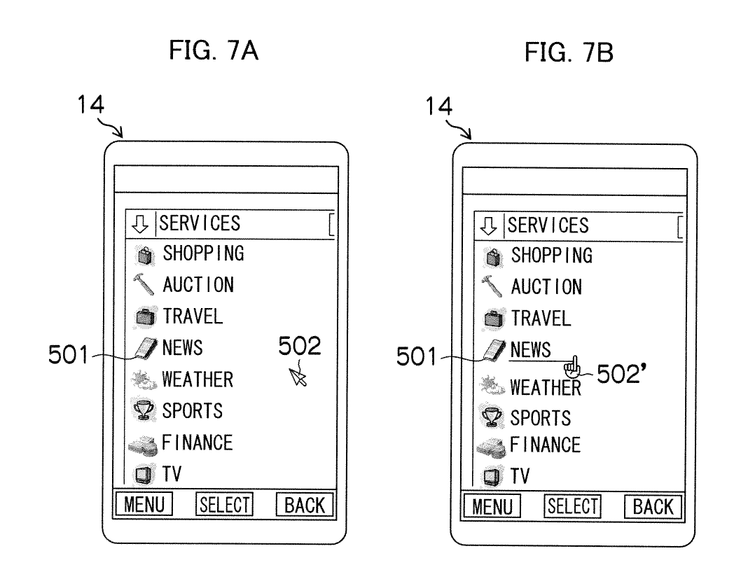

FIGS. 7A and 7B are diagrams illustrating the case where a cursor moves according to an operation. FIG. 7B illustrates display in the case where a movement-toward-upper-left operation is performed in the state in FIG. 7A. When a cursor 502 is moved onto a UI information position 501 (here, a link) at the upper left of the screen according to the user operation, the UI information position 501 is underlined, and the cursor 502 is displayed as a cursor 502′ in a changed shape.

By performing an operation with a decision button, a link destination associated with the UI information position 501 can be displayed as described later.

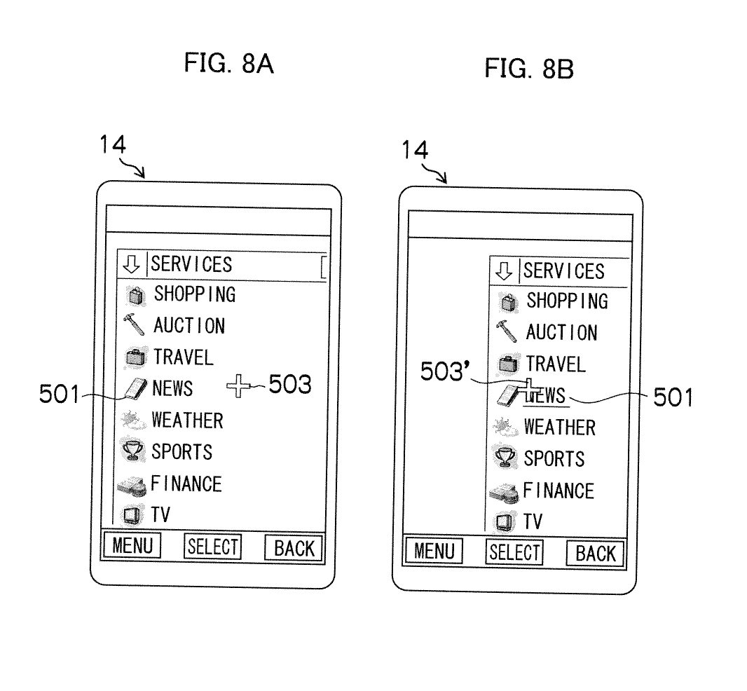

FIGS. 8A and 8B are diagrams illustrating the case of a configuration in which, when an up-to-down, down-to-up, right-to-left or left-to-right movement operation is performed similarly, the image moves according to the operation. FIG. 8B illustrates display in the case where a movement-toward-right operation is performed in the state of FIG. 8A. A cursor 503 is displayed being fixed in the center of the screen on the display section 14. The displayed image moves according to a user operation. When the UI information position 501 on the image is moved onto the cursor 503, the UI information position 501 on the image is underlined, and the cursor 503 is displayed as a cursor 503′ in a changed color.

If an enlargement/reduction operation is performed at step S44, the image is displayed with a magnification changed according to the operation (step S46).

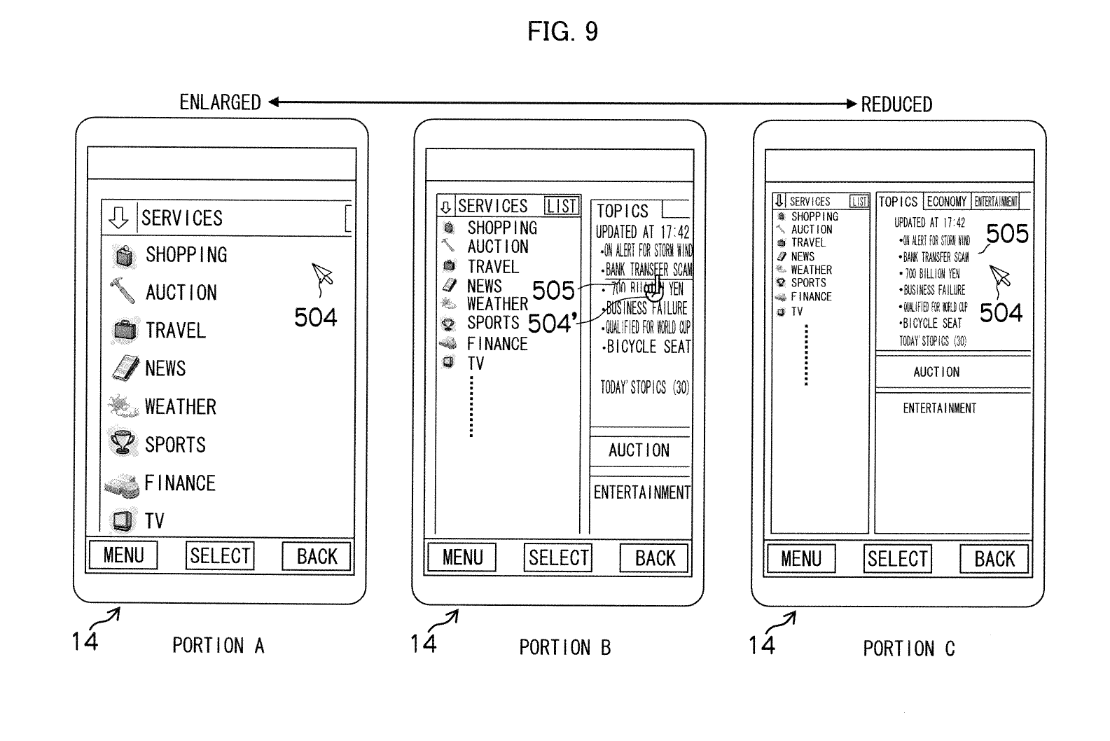

FIG. 9 is a diagram for illustrating the image displayed on the display section 14 in the case where an enlargement/reduction operation is performed. When a reduction operation is performed in the state illustrated in Portion A of FIG. 9, the image is displayed in a reduced size as illustrated in Portion B of FIG. 9. By further operating a reduction operation, the image can be displayed as illustrated in Portion C of FIG. 9.

When an enlargement operation is performed in the state illustrated in Portion C of FIG. 9, the image in Portion C of FIG. 9 is displayed in an enlarged size as illustrated in Portion B of FIG. 9. By further operating an enlargement operation, the image can be displayed as illustrated in Portion A of FIG. 9.

In FIG. 9, the position of a cursor 504 in the screen is not changed. However, since the display magnification of the displayed image is changed with a position other than the display position of the cursor 504 as the center, the position of the cursor 504 on the image moves.

As a result, though the position of the cursor 504 does not overlap with a UI information position on the image in the state illustrated in Portion A of FIG. 9, a UI information (link) position 505 on the image overlaps with the position of the cursor 504 in the state illustrated in Portion B of FIG. 9. Therefore, the UI information position 505 on the image is underlined, and the cursor 504 is displayed as a cursor 504′ in a changed shape.

If an operation by the decision button (a click operation) is performed at step S44, it is determined whether or not the cursor position and a UI information position on the image overlap with each other on the basis of the result of the comparison at step S42 (step S47).

If the cursor position does not overlap with a UI information position on the image, the processing section 12 nullifies the click operation, the process returns to step S42 and the processing section 12 performs similar processing.

If the cursor position overlaps with a UI information position on the image, the processing section 12 determines the classification of UI information which exists at the position overlapping with the cursor position on the basis of the UI metadata (step S48).

As classifications of UI information, the following three are conceivable: (1) UI information which requires input by the user, such as a text input field, (2) UI information which is not accompanied by screen transition and does not require data input, such as a checkbox and a radio button, and (3) UI information accompanied by screen transition, such as a link and a button.

In the case where the classification of the UI information existing at the cursor position is (1) UI information which requires input by the user, such as a text input field, a data input screen is displayed on the display section 14 by pop-up or the like to request input from the user (step S49). The user performs necessary data input by the input device 13 on this input screen (step S50). The processing section 12 rewrites UI metadata stored in the storage section (not illustrated) according to the user input (step S51). The rewritten UI metadata is transmitted to the integrated server 30 together with a rewritten UI information ID and the session ID received at step S41 via the communication section 11 (step S52).

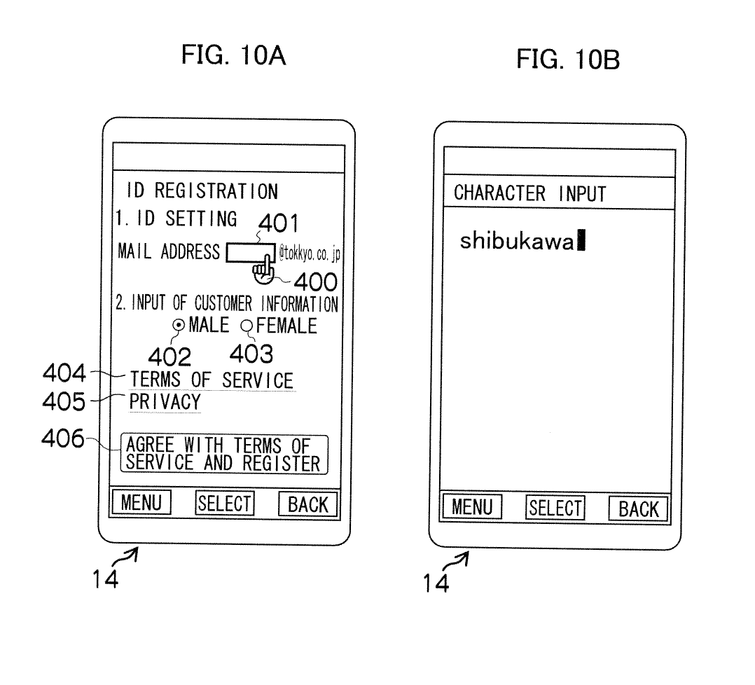

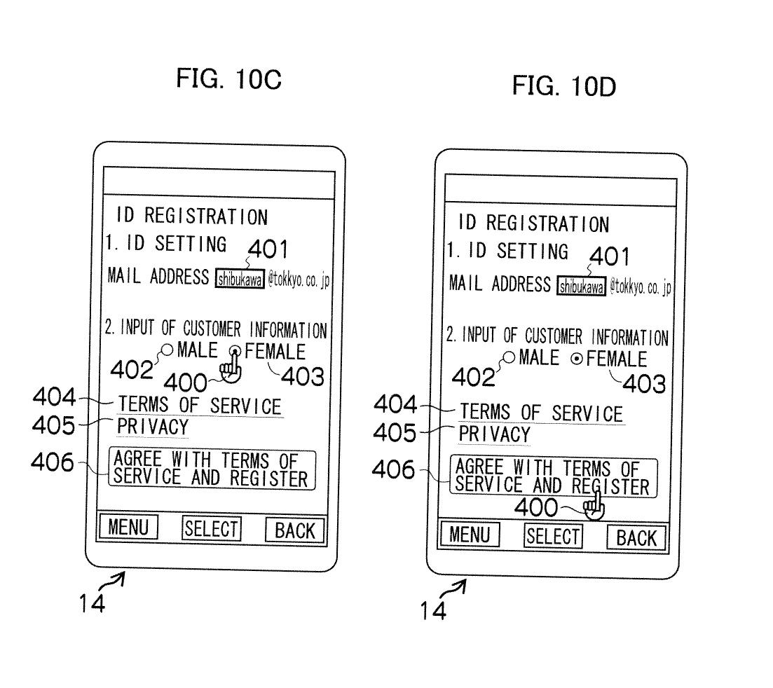

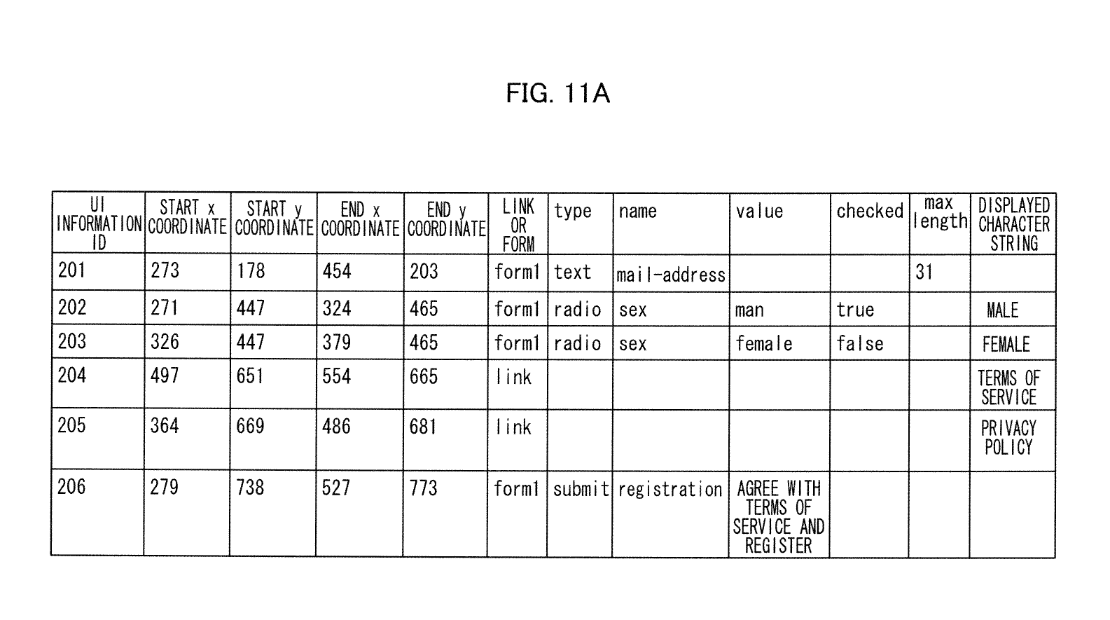

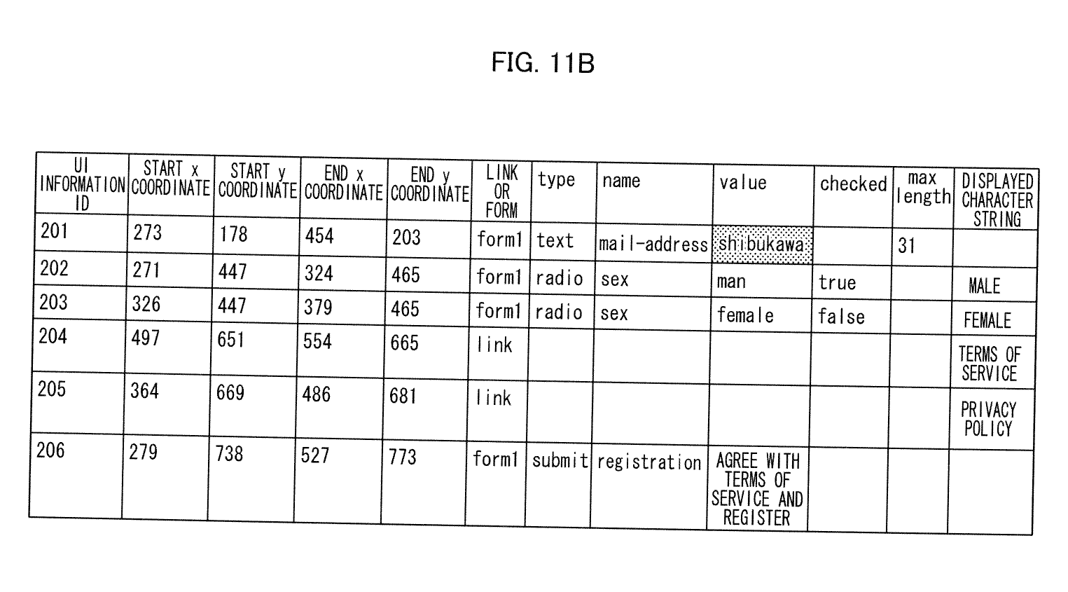

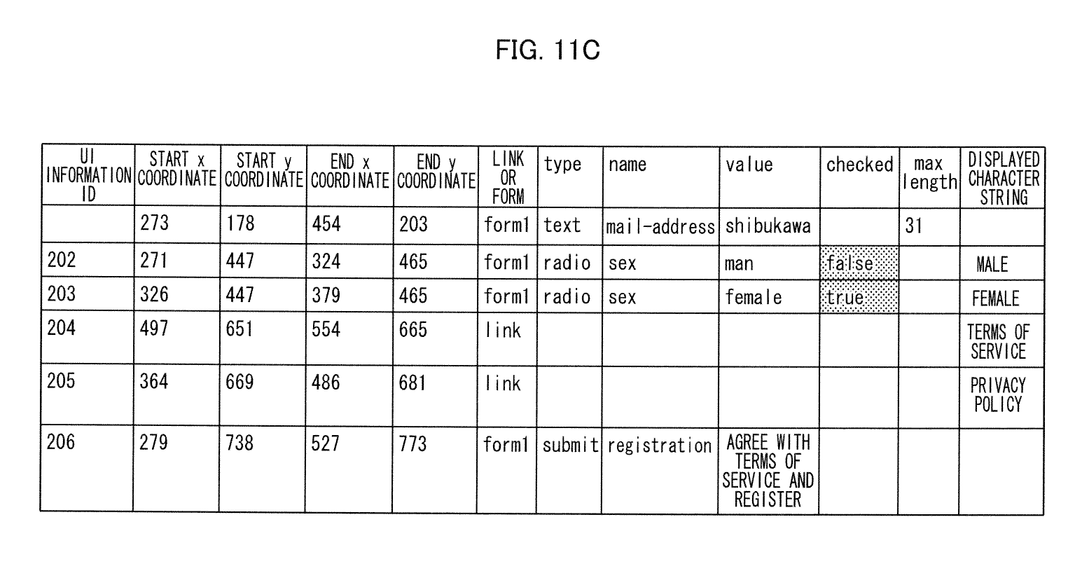

The details of rewriting of UI metadata will be described with reference to FIGS. 10A to 10D and 11A to 11C.

FIG. 10A is a diagram illustrating that the image illustrated in FIG. 4C is displayed on the display section 14. On positions 401 to 406 on the displayed image, pieces of UI information 201 to 206 are displayed as illustrated in the UI metadata illustrated in FIG. 11A. When the user moves a cursor 400 onto the position 401 corresponding to the UI information 201 and performs a click operation, a text input pop-up screen is displayed on the display section 14 as illustrated in FIG. 10B.

The user inputs desired characters using the input device 13 on this pop-up screen. When a click operation is performed via the input device 13 after inputting text, the processing section 12 rewrites a value attribute of the UI information 201 corresponding to the position 401, on the basis of the inputted text. Since the user inputs “shibukawa” on the text input pop-up screen as illustrated in FIG. 10B, the value attribute of the UI information 201 is rewritten to “shibukawa” as illustrated in FIG. 11B.

This rewritten UI metadata is transmitted to the integrated server 30 via the communication section 11 together with the ID of the rewritten (executed) UI information (here, 201).

Next, description will be made on the case where corresponding UI information is (2) UI information which is not accompanied by UI screen transition and does not require data input.

At each of the position 402 corresponding to the UI information 202 and the position 403 corresponding to the UI information 203 illustrated in FIG. 10C, a radio button for specifying sex is displayed. As illustrated in FIG. 4, the basis tags 302 and 303 of the UI information 202 and the UI information 203 have the same name attribute. That is, any one of the UI information 202 and the UI information 203 can be selected. In the default setting, the checked attribute of the UI information 202 is true, and the checked attribute of the UI information 203 is false, as illustrated in FIG. 11A. Therefore, the UI information 202 is selected as illustrated in FIG. 10A.

When the cursor 400 is moved onto the position 403 corresponding to the UI information 203, and a click operation is performed, the processing section 12 determines the classification of the UI information which exists at the position overlapping the cursor position on the basis of the UI metadata.

Here, the UI information 203 is a radio button, which is UI information that does not require data input and is not accompanied by screen transition. Therefore, the processing section 12 proceeds to step S51, and the processing section 12 rewrites data about the UI information 203 in the UI metadata stored in the storage section (not illustrated).

FIG. 11C is a diagram illustrating the UI metadata rewritten in this case. As illustrated in FIG. 11C, the checked attribute of the UI information 203 has been rewritten to true, and the checked attribute of the UI information 202 which has the same name attribute as the UI information 203 has been rewritten to false.

Lastly, description will be made on the case where corresponding UI information is (3) UI information accompanied by screen transition. The UI information accompanied by screen transition refers to such UI information that an image different from a currently displayed image is displayed as a result of executing the UI information.

As illustrated in FIG. 10D, what is displayed at the position 406 corresponding to the UI information 206 is a transmission button. By performing a click operation at the position 406, the screen transitions to a different screen in accordance with the description in the button tag 306. When the cursor 400 is moved onto this position 406, and a click operation is performed, the processing section 12 determines the classification of UI information which exists at the position overlapping the cursor position on the basis of the UI metadata.

Here, the UI information 206 is a button, which is UI information accompanied by screen transition. Therefore, the processing section 12 proceeds to step S52. Then, the ID of the executed UI information (here, 206) and the session ID received at step S41 are transmitted to the integrated server 30 via the communication section 11 together with the UI metadata (step S52).

As described above, no matter which classification of UI information a click operation is performed for, UI metadata and the ID of the executed UI information are transmitted to the integrated server 30 together with a session ID. Therefore, the integrated server 30 can certainly acquire information about which webpage was browsed on which mobile terminal 10, and which operation was operated thereon.

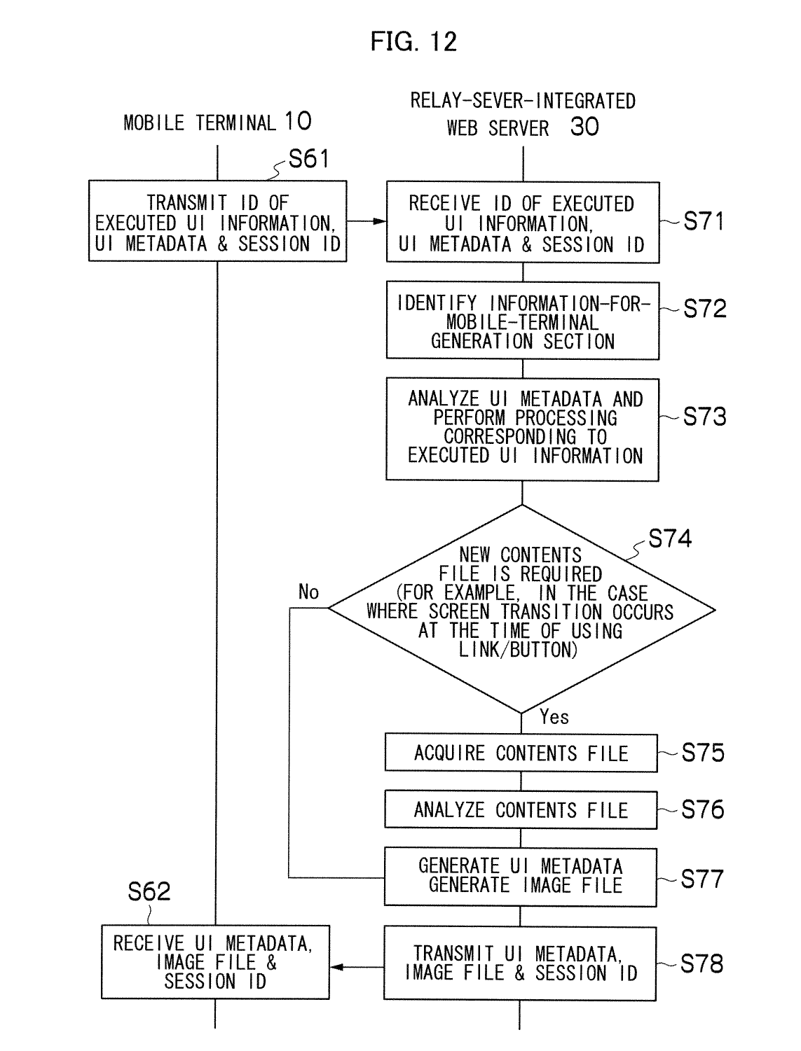

Next, the operation of the webpage browsing system 100 based on the ID of executed UI will be described with reference to FIG. 12.

When UI metadata, the ID of executed UI information and a session ID are transmitted from the mobile terminal 10 (step S61), the integrated server 30 receives them via the communication section 31 (step S71).

The authentication section 34 receives the session ID via the communication section 31, and refers to the session DB 35 to identify an information-for-mobile-terminal generation section 33 associated with the session ID (step S72).

If, at step S72, the session ID is not stored when the session DB 35 is referred to, it is possible to separately issue a session ID and assign an information-for-mobile-terminal generation section 33 in methods similar to those at steps S22 and S23. In this case, the subsequent process can be performed by the information-for-mobile-terminal generation section 33 assigned here.

When the information-for-mobile-terminal generation section 33−1 is identified at steps S72, the UI information analysis section 33B−1 acquires the UI metadata and the ID of the executed UI information via the communication section 31, analyzes them, and analyzes which UI information in the UI metadata was executed (step S73).

The UI information analysis section 33B−1 determines whether or not it is necessary to acquire a new contents file, on the basis of the executed UI information (step S74). For example, the determination is made in the case where a link button is operated and screen transition occurs.

If the executed UI information requires acquisition of a new contents file, a transition-destination URL address is acquired from a contents file stored in the session DB in association with the session ID, and the contents file corresponding to this URL address is acquired from the web contents storage area 32 (step S75). The UI information analysis section 33B−1 analyzes the contents file of the transition destination (step S76).

Furthermore, the UI information analysis section 33B−1 generates UI metadata of the transition destination on the basis of the result of this analysis, and the image conversion section 33A−1 generates an image file on the basis of the contents file of the transition destination (step S77). The contents file of the transition destination is stored into the session DB 35 in association with the UI metadata and image file of the transition destination and in association with a session ID. The session ID associated here is the same session ID issued at step S22. Thereby, processing for a certain session ID is managed together with information about a communication-counterpart mobile terminal 10.

The image file and UI metadata of the transition destination, and a session ID are transmitted to the mobile terminal 10 via the communication section 31 (step S78). The session ID transmitted here is the same session ID issued at step S22.

The mobile terminal 10 receives the image file, the UI metadata and the session ID via the communication section 11, and displays the image file on the display section 14 as a transition-destination screen (step S62).

If it is determined at step S73 that the executed UI information is UI information which does not require acquisition of a new contents file, the flow proceeds to step S77, where a contents file associated with the session ID received at step S71, that is, a contents file corresponding to the rewritten UI metadata is read from the session DB 35, and a new image file is generated on the basis of the rewritten UI metadata. It is also possible to, on the basis of the image of the original contents file and the ID of the executed UI information, change only a part of the image for which rewriting is required because of the execution, instead of generating a new image file.

The new image file, the UI metadata and the session ID are transmitted to the mobile terminal 10 via the communication section 31 (step S78). The mobile terminal 10 receives the image file and the UI metadata via the communication section 11 and displays the image file on the display section 14 (step S62).

For example, if the executed UI information is the UI information 201 (a text input field) illustrated in FIG. 10A, the rewritten UI metadata illustrated in FIG. 11B and the ID 201 of the executed UI information are transmitted from the mobile terminal 10 (step S61). The integrated server 30 receives them via the communication section 31 (step S71).

The image conversion section 33A reads a contents file associated with the rewritten UI metadata from the storage section (not illustrated), and generates a new image file on the basis of the rewritten UI metadata. This new image file is an image in which the character “shibukawa” inputted at step S50 is displayed at the position of a text input field, as illustrated in FIG. 10C.

If the executed UI information is the UI information 203 (a radio button) illustrated in FIG. 10C, the rewritten UI metadata illustrated in FIG. 11C and the ID 203 of the executed UI information are transmitted from the mobile terminal 10 (step S61). The integrated server 30 receives them via the communication section 31 (step S71).

The image conversion section 33A reads a contents file associated with the rewritten UI metadata from the storage section (not illustrated), and generates a new image file on the basis of the rewritten UI metadata. This new image file is an image in which the position of the radio button checkmark is changed from the position 402 to the position 403, as illustrated in FIG. 10D.

Furthermore, if the executed UI information is the UI information 206 (a button) illustrated in FIG. 10D, the UI metadata (which is not rewritten, in this case) and the ID 206 of the executed UI information are transmitted from the mobile terminal 10 (step S61). The integrated server 30 receives them via the communication section 31 (step S71).

The integrated server 30 which has received them acquires a transition-destination URL from the UI metadata, requires (step S74) and receives (step S75) a relevant contents file from a relevant external web server 50. On the basis of this contents file, UI metadata is generated by the UI information analysis section 33B−1, and an image file is generated by the image conversion section 33A (step S76 and S77).

This image file and UI metadata of the transition destination are transmitted to the mobile terminal 10 (step S78), and the image file is displayed on the display section 14 (step S62).

As described above, even when a UI operation accompanied by screen transition is performed, a new transition-destination webpage can be displayed and, furthermore, UI information can be operated similarly.

Since the mobile terminal 10 receives a session ID at step S62, it is possible to, when UI information is executed on the mobile terminal 10 next, transmit the UI metadata and the ID of the executed UI information to the integrated server 30 together with the session ID. In the integrated server 30, since a different session ID is assigned to each of mobile terminals 10 which communicate with the integrated server 30 and stored in the session DB, it is possible to manage connection with the mobile terminals 10 and processing performed thereon, for each session ID, that is, for each mobile terminal 10.

As described above, the webpage browsing system 100 can realize high-speed and user-friendly webpage browsing. Especially, because contents files are stored in the integrated server 30, the speed can be further increased in comparison with the case of acquiring a contents file from an external web server. Furthermore, it is possible for multiple mobile terminals 10 to connect to the integrated server 30, and it is possible to manage processing for each of the mobile terminals 10.

In this embodiment, a session ID, the information-for-mobile-terminal generation section 33−1 and a user agent are stored into the session DB in association with one another (step S23). However, it is not necessarily required to store the user agent in association with the session ID. However, by associating the user agent with the session ID, generate an image, it is possible for the image conversion section 33A to generate an image with a size suitable for the display section of the mobile terminal 10 or an image with a data amount suitable for the processing ability of the mobile terminal 10. Therefore, it is desirable to associate the user agent also with the session ID and the like. In order for the image conversion section 33A to generate an image with a size suitable for the display section of the mobile terminal 10 or an image with a data amount suitable for the processing ability of the mobile terminal 10 in the case where a user agent is not stored in association with a session ID, a user agent can be transmitted each time a URL address and the ID of executed UI information are transmitted from the mobile terminal 10.

In this embodiment, the integrated server 30 which includes the function of an external web server is used. However, an external web server and a relay server may be separately provided as illustrated in a second embodiment. Furthermore, such a configuration is also possible that the integrated server can connect to multiple external web servers existing in the Internet. The integrated server 30 and the external web servers are connected via the Internet, and each of the communication section 31 and the communication sections of the external web servers performs communication in accordance with standard Internet protocols. Thereby, even a contents file which is not stored in the integrated server 30 can be browsed (as for a method for the integrated server 30 to acquire a contents file from an external web server, see the second embodiment).

### Second Embodiment

The second embodiment is such that an authentication function of authenticating a communication-counterpart mobile terminal 10 is provided. A webpage browsing system 101 according to the second embodiment will be described below. The same portions as in the first embodiment are given the same reference numerals, and description thereof will be omitted. Since the internal process of a mobile terminal 10 is the same as that in the first embodiment, description thereof will be omitted.

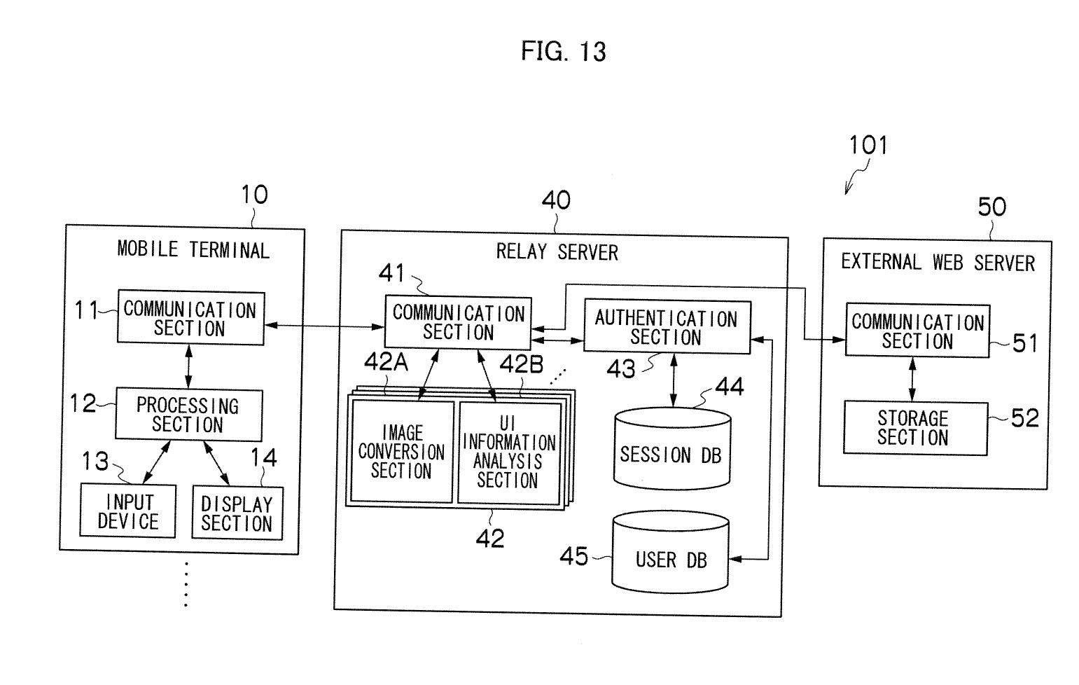

FIG. 13 is a diagram illustrating an example of the whole configuration of the webpage browsing system 101. As illustrated in FIG. 13, the webpage browsing system 101 includes multiple mobile terminals 10 used by users and a relay server 40 which relays communication between the mobile terminals 10 and an external web server 50.

The relay server 40 includes a communication section 41, multiple information-for-mobile-terminal generation sections 42 (each of which includes an image conversion section 42A and a UI information analysis section 42B), an authentication section 43, a session DB 44 and a user DB 45.

The communication section 41 controls communication with the mobile terminals 10 and controls communication with the external web server 50. The relay server 40 and the external web server 50 are connected via the Internet, and each of the communication section 41 and a communication section 51 performs communication in accordance with standard Internet protocols.

There exist the same number of information-for-mobile-terminal generation section 42 as the number of session IDs issued by the authentication section 43 to be described later. The information-for-mobile-terminal generation section 42 includes the image conversion section 42A and the UI information analysis section 42B. Since the image conversion section 42A is the same as the image conversion section 33A, and the UI information analysis section 42B is the same as the UI information analysis section 33B, description thereof will be omitted. The concept of having multiple information-for-mobile-terminal generation sections 42 includes the case where there are multiple information-for-mobile-terminal generation sections 42, the case where there is one information-for-mobile-terminal generation section 42 in which each of the image conversion section 42A and the UI information analysis section 42B are divided into multiple areas, and the like, similarly to the first embodiment.

In the user DB 45, information about a mobile terminal 10 for which the relay server 40 relays communication with the external web server 50 is stored together with a user ID. The information about a mobile terminal 10 is information indicating the mobile terminal 10, such as a user agent, a password and the like.

When a mobile terminal 10 connects to the communication section 41, the authentication section 43 acquires information indicating the mobile terminal 10 (for example, a user agent) from the mobile terminal 10 and determines whether the acquired information indicating the mobile terminal 10 is stored in the user DB 45. If the acquired information indicating the mobile terminal 10 is stored in the user DB 45, the authentication section 43 issues a session ID. Thereby, it is possible to perform relay to the external web server 50 only for a determined mobile terminal 10.

Then, the authentication section 43 associates one of the multiple information-for-mobile-terminal generation sections 42 with the issued session ID, stores information about the association into the session DB 44 to perform session management. Thereby, separate communication can be made with each of the multiple mobile terminals 10.

If the mobile terminal 10 does not access for a predetermined time or more after the session ID is issued, the authentication section 43 ends (terminates) the session and deletes the data about the session ID stored in the session DB. Thereby, it becomes possible to issue the session ID when another mobile terminal 10 or the like accesses.

The external web server 50 includes a communication section 51 and a storage section 52.

The communication section 51 controls communication with the relay server 40. The storage section 52 stores the contents file of webpages established in the external web server 50. The communication section 51 reads a file in response to a URL request received from the relay server 40 and transmits it to the relay server 40.

Though only one external web server 50 is illustrated in FIG. 13, there are a lot of external web servers 50 in the Internet network which can communicate with the relay server 40, and the relay server 40 can communicate with each of the external web servers 50. Thus, no matter which mobile terminal 10 accesses which external web server 50, communication is performed via the relay server 40.

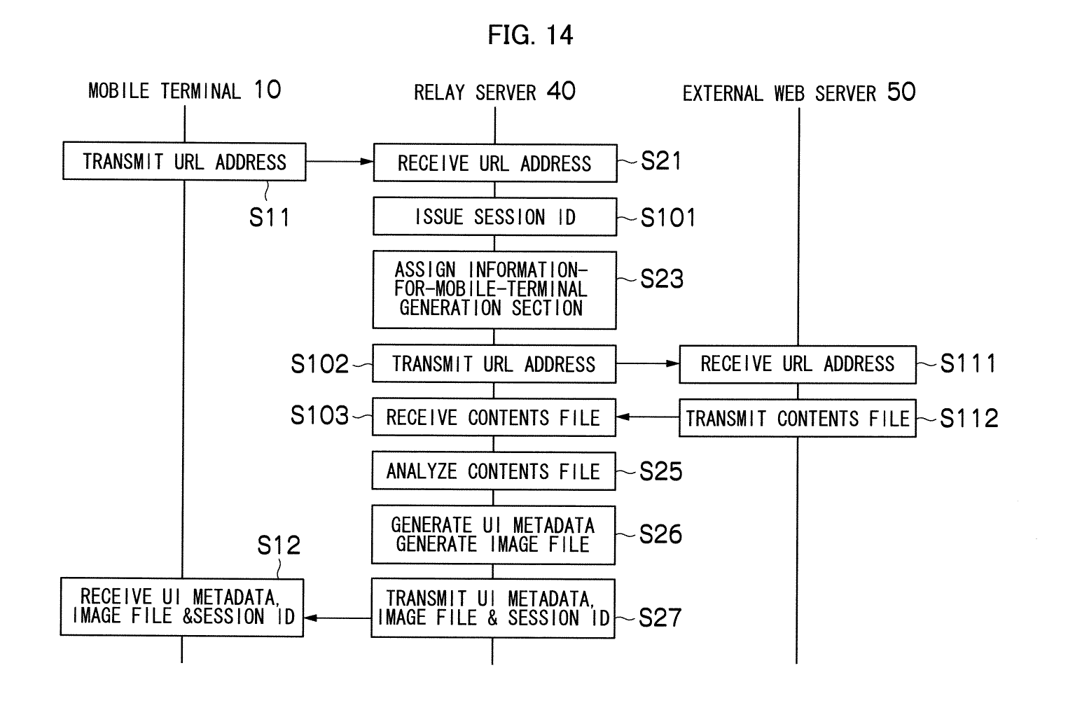

Next, the operation of the webpage browsing system 101 configured as described above will be described. First, the operation performed before a desired webpage is displayed on a display section 14 of the mobile terminal 10 will be described with reference to FIG. 14.

When the URL address of a webpage to be browsed is inputted with the use of an input device 13 of the mobile terminal 10, the mobile terminal 10 transmits the URL address and information indicating the mobile terminal 10 to the relay server 40 via the communication section 11 (step S11).

The relay server 40 receives the URL address and information indicating the mobile terminal 10 transmitted from the mobile terminal 10, via the communication section 41 (step S21). The communication section 41 outputs the information indicating the mobile terminal 10 to the authentication section 43, and the authentication section 43 determines whether the information indicating the mobile terminal 10 is stored in the user DB 45. If the information indicating the mobile terminal 10 is stored in the user DB 45, the authentication section 43 issues a session ID (step S101).

The authentication section 43 assigns an information-for-mobile-terminal generation section 33−1 to the session ID, and causes the session ID, the information-for-mobile-terminal generation section 33−1 and a user agent to be stored into the session DB in association with one another (step S23).

The communication section 41 transmits the received URL address to an external web server 50 corresponding to the URL (step S102). If a webpage title is selected with the use of a bookmark in the integrated server 30, a corresponding URL address can be read from the storage section (not illustrated) and transmitted to a relevant external web server 50.

The corresponding external web server 50 receives this URL address via a communication section 31 (step S111). Then, the external web server 50 reads a contents file, such as an HTML file, a CSS file and a Java Script file, corresponding to the received URL address from the storage section 52 and transmits it to the relay server 40 via the communication section 51 (step S112).

The communication section 41 receives the contents file transmitted from the external web server 50 (step S103). The received contents file is outputted to an image conversion section 33A−1 and a UI information analysis section 33B−1.

The UI information analysis section 33B−1 analyzes the contents file and extracts UI information (step S25). The UI information analysis section 33B−1 generates UI metadata on the basis of the result of this analysis, and the image conversion section 33A−1 performs rendering of the contents file and generates an image file in a format which can be displayed on the display section 14 of the mobile terminal 10 (step S26).

The relay server 40 transmits the UI metadata and image file generated at step S26 and the session ID issued at step S22 to the mobile terminal 10 via the communication section 41 (step S27). At this time, the basis contents file is stored into the session DB 44 in association with the transmission-destination mobile terminal 10, the generated UI metadata, the image file and the session ID. The mobile terminal 10 receives the UI metadata and the image file via the communication section 11 (step S12).

Thereby, it is possible to transmit UI metadata and an image file to a mobile terminal 10 registered with the user DB 45 in advance.

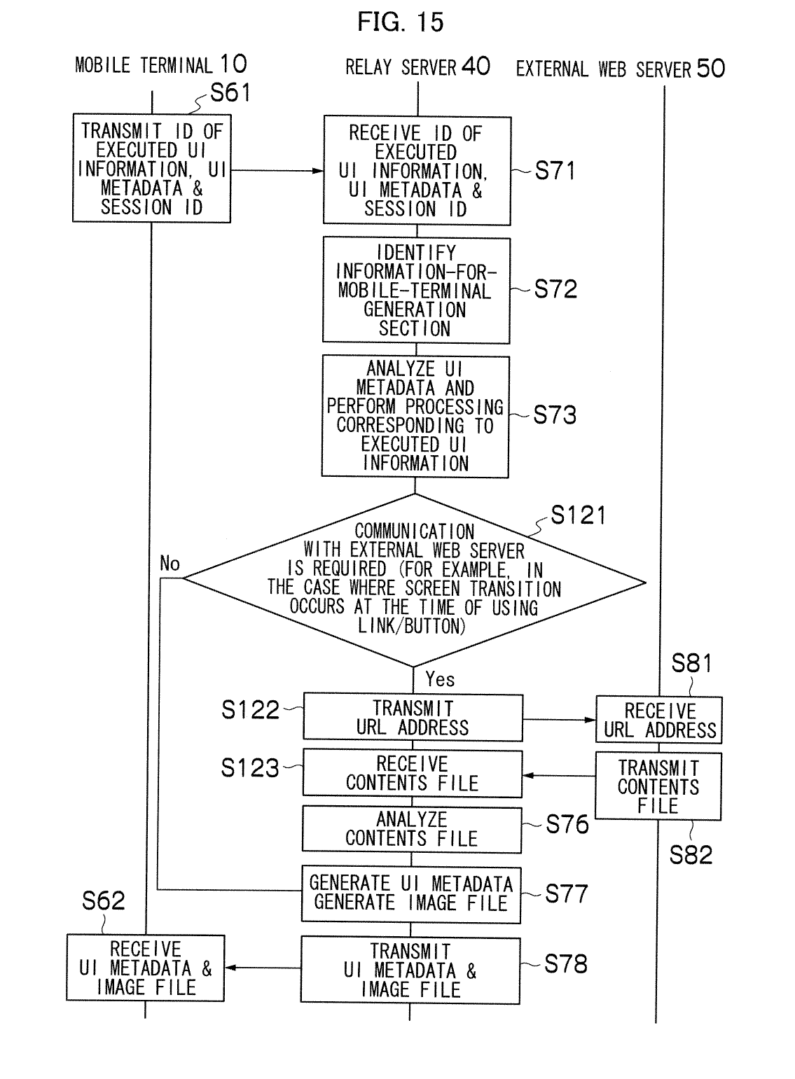

Next, the operation of the webpage browsing system 101 based on the ID of executed UI information will be described with reference to FIG. 15.

When UI metadata, the ID of executed UI information and a session ID are transmitted from a mobile terminal 10 (step S61), the relay 40 receives them via the communication section 41 (step S71), and the authentication section 43 refers to the session DB 44 to identify an information-for-mobile-terminal generation section 33−1 associated with the received session ID (step S72).

The UI information analysis section 33B−1 analyzes the UI metadata and the ID of the executed UI information which have been received, and analyzes which UI information in the UI metadata was executed (steps S73).

The UI information analysis section 33B−1 determines whether or not it is necessary to acquire data from an external web server 50 (step S121) on the basis of the executed UI information. For example, the determination is made in the case where a link button is operated and screen transition occurs.

If it is necessary to acquire data from an external web server 50 (steps S121: YES), the communication section 41 transmits the received URL address to an external web server 50 corresponding to the URL address (step S122). If a webpage title is selected with the use of a bookmark in the integrated server 30, a corresponding URL address can be read from the storage section (not illustrated) transmitted to a relevant external web server 50.

The relevant external web server 50 receives this URL address via the communication section 31 (step S81). Then, the external web server 50 reads a contents file, such as an HTML file, a CSS file and a Java Script file, corresponding to the received URL address from the storage section 52 and transmits it to the relay server 40 via the communication section 51 (step S82).

The communication section 41 receives the contents file of the transition destination and outputs it to the information-for-mobile-terminal generation section 33−1. The UI information analysis section 33B−1 analyzes the contents file of the transition destination (step S76).

Furthermore, the UI information analysis section 33B−1 generates UI metadata of the transition destination on the basis of the result of this analysis, and the image conversion section 33A−1 generates an image file on the basis of the contents file of the transition destination file (step S77). The image file and UI metadata of the transition destination, and a session ID are transmitted to the mobile terminal 10 via the communication section 41 (step S78).

The mobile terminal 10 receives the image file, the UI metadata and the session ID via the communication section 11, and displays the image file on the display section 14 as a transition-destination screen (step S62).

If it is not necessary to acquire data from an external web server 50 (step S121: NO), the flow proceeds to step S77, where the image conversion section 33A−1 reads the created (rewritten) UI metadata and a related contents file from the storage section (not illustrated) in the image conversion section 42A, and generates a new image file on the basis of the created (rewritten) UI metadata. It is also possible to, on the basis of the image of the original contents file and the ID of the executed UI information, change only a part of the image for which rewriting is required because of the execution, instead of generating a new image file.

The new image file, the UI metadata and the session ID are transmitted to the mobile terminal 10 via the communication section 41 (step S78). The mobile terminal 10 receives the image file, the UI metadata and the session ID via the communication section 11, and displays the image file on the display section 14 (step S62).

As described above, the webpage browsing system 101 can realize high-speed and user-friendly webpage browsing. Furthermore, by issuing a session ID only to a mobile terminal registered with the user DB, an authentication function can be provided. Therefore, security can be enhanced.

Though the webpage browsing system 101 of this embodiment includes the mobile terminals 10, the relay server 40 and the external web server 50, an integrated server which includes a relay server and an external web server can be used similarly to the first embodiment. However, because there is provided an authentication function of issuing a session ID only to a mobile terminal 10 registered with the user DB 45 in this embodiment, it is desirable that the function of a web server to which an unspecified number of users may connect should be separated from the relay server.

### Third Embodiment

A third embodiment is different from the first or second embodiment only in the internal process of a mobile terminal 10.

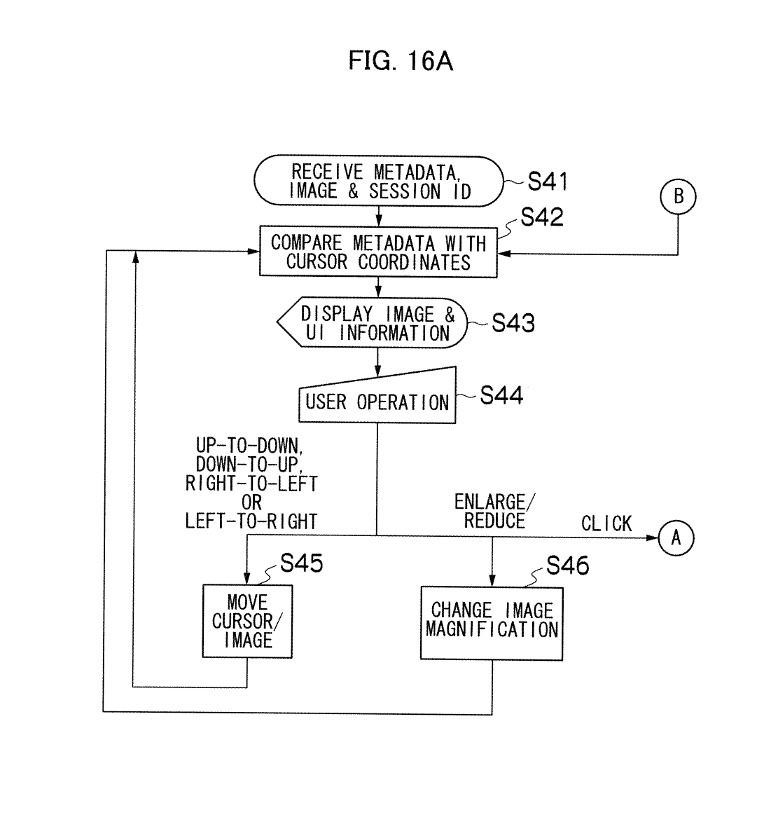

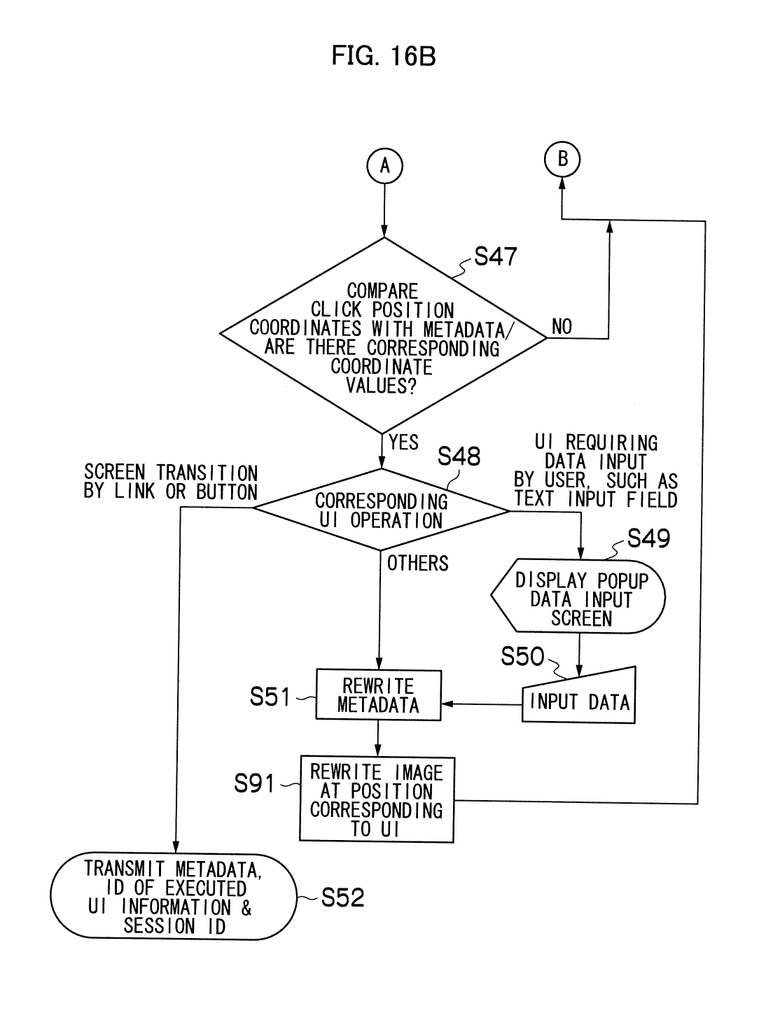

FIGS. 16A and 16B are flowcharts illustrating the internal process of the mobile terminal 10 of the third embodiment. Portions common to the flowcharts in FIGS. 6A and 6B are given the same reference numerals, and description thereof will be omitted.

In the case where text is inputted at position 401 corresponding to UI information 201 in the state illustrated in FIG. 10A, UI metadata is rewritten as illustrated in FIG. 11B. At this time, the mobile terminal 10 of the third embodiment does not perform communication with an integrated server 30 but a processing section 12 generates the image illustrated in FIG. 10C (step S91). After that, the flow returns to step S42, and similar processing is performed.

Similarly, in the case where position 403 corresponding to UI information 203 is clicked in the state illustrated in FIG. 10C also, communication with the integrated server 30 is not performed, and the processing section 12 generates the image illustrated in FIG. 10D in which a check position has moved. After that, the flow returns to step S42, and similar processing is performed.

As described above, by making such a configuration that, when image rewriting occurs without being accompanied by screen transition, the mobile terminal 10 rewrites the image, it is possible to reduce the amount of communication between the mobile terminal 10 and the integrated server 30 and, furthermore, eliminate the communication time therefor, and therefore, it is possible to improve the operability of the mobile terminal 10.

### Fourth Embodiment

A fourth embodiment is different from the first or second embodiment only in the internal process of a mobile terminal 10.

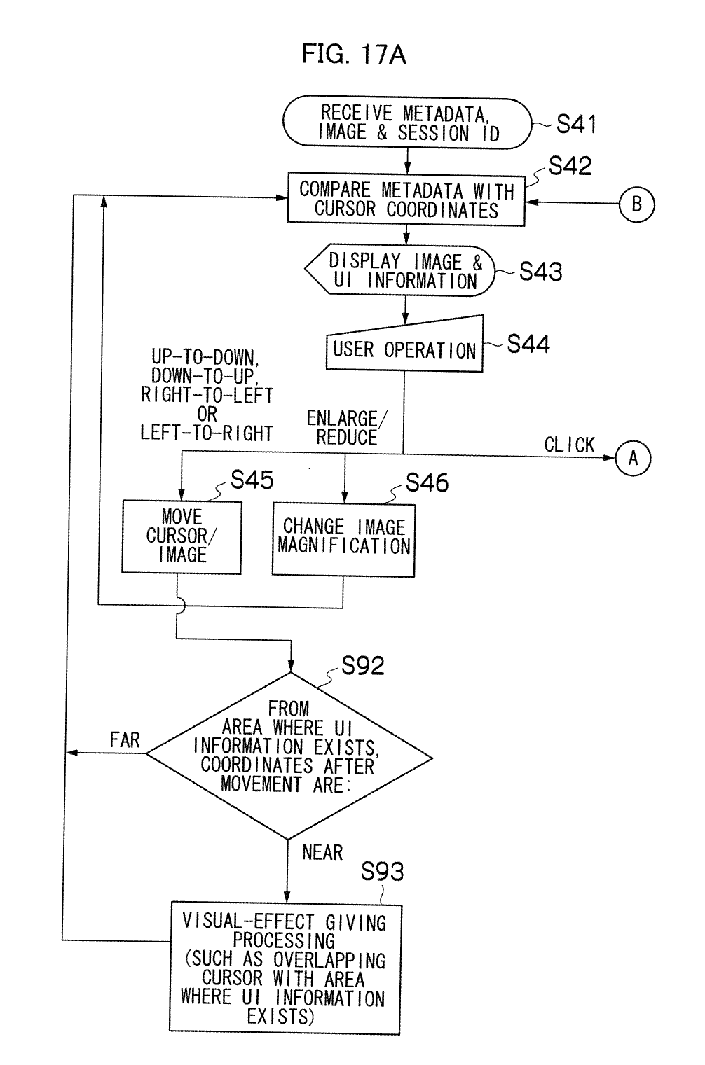

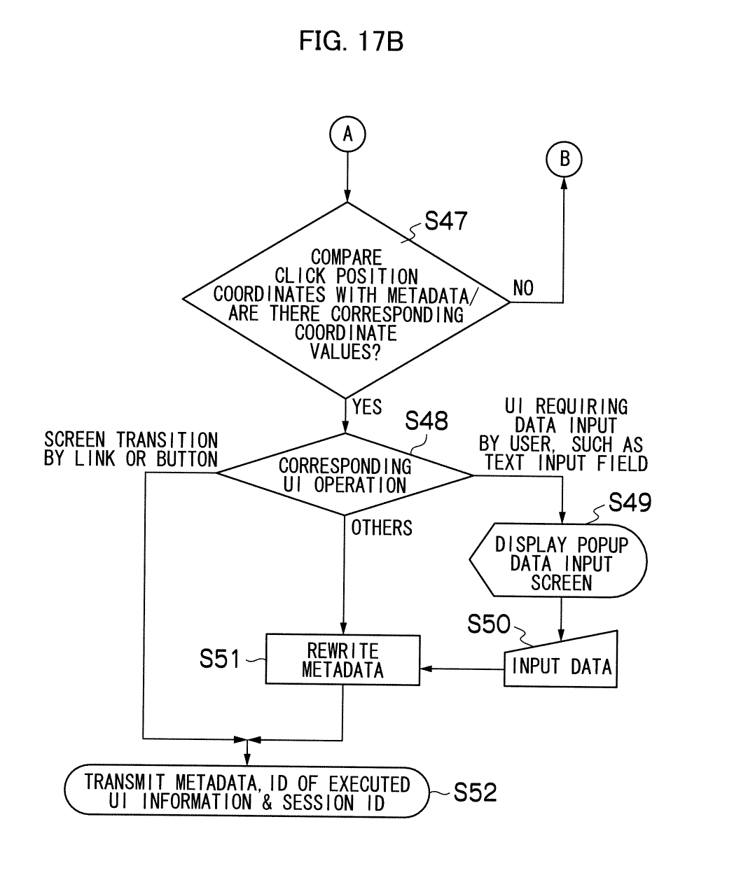

FIGS. 17A and 17B are flowcharts illustrating the internal process of the mobile terminal 10 of the fourth embodiment. Portions common to the flowchart in FIGS. 6A and 6B are given the same reference numerals, and description thereof will be omitted.

The mobile terminal 10 of the fourth embodiment is different from that of the first embodiment in that visual-effect giving processing is performed according to a cursor position and a UI information position.

When an up-to-down, down-to-up, right-to-left or left-to-right movement operation by a cross key or the like is performed at step S45 in FIGS. 17A and 17B, a processing section 12 moves the cursor or the image according to the operation.

When the movement operation ends, the position coordinates of the cursor after the movement is calculated, and it is determined whether or not the calculated position coordinates are near the area where UI information exists, on the basis of the calculated position coordinates and UI metadata (step S92). Here, it is determined whether they are near or not, on the basis of a predetermined number of pixels as a threshold. This threshold can be determined according to the enlargement rate or the like of the image displayed on a display section 14.

If it is determined that the position coordinates are not near, the flow proceeds to step S42 similarly to the first embodiment. If it is determined that they are near, the processing section 12 performs visual-effect giving processing (step S93).

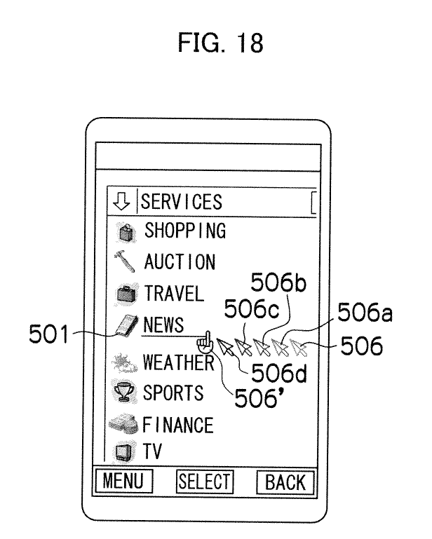

For example, the cursor is automatically moved to a position corresponding to the nearest UI information as illustrated in FIG. 18. In the example of FIG. 18, a cursor 506 is automatically moved to UI information position 501, changed to a cursor 506′ and displayed on the UI information position 501. While the cursor 506 is moving, residual images 506a, 506b, 506c and 506d are displayed on the locus of the movement.

In the case of a configuration in which an image moves according to an operation, the image can be moved so that UI information nearest to a cursor fixed in the center of the screen overlaps the cursor.

By making a configuration as described above, it is possible to improve the operability at the time of browsing a website.

What is claimed is:

1. A website browsing system in which multiple client terminals connect to a server, wherein
the server comprises:
a first receiving device configured to acquire page contents requested by a predetermined client terminal among the multiple client terminals;
multiple information generation devices each of which includes a conversion device configured to convert the acquired page contents to an image and a UI information metadata generating device configured to extract UI information from the acquired page contents and to generate UI information metadata on the basis of the extracted UI information;
a session management device configured to, upon receiving the request from the predetermined client terminal, issue a session ID for identifying the predetermined client terminal and to manage the issued session ID and a desired information generation device among the multiple information generation devices in association with each other; and
a first transmission device configured to transmit the converted image, the generated UI information metadata and the issued session ID to the predetermined client terminal, and
the client terminal comprises:
a second transmission device configured to request desired page contents from the server;
a second receiving device configured to receive the image of the requested page contents, the UI information metadata and the session ID which have been transmitted from the server;
a display device configured to display the image on the basis of the received image and UI information metadata; and
a display control device configured to display the received image on the display device and to display the UI information on the image on the basis of the UI information metadata.

2. The website browsing system according to claim 1, wherein
when the first receiving device receives a request from a client terminal other than the predetermined client terminal, among the multiple client terminals, the session management device generates a session ID for identifying the client terminal other than the predetermined client terminal, which is a session ID different from the session ID for identifying the predetermined client terminal, and manages the generated session ID and an information generation device which is not associated with a session ID among the multiple information generation devices in association with each other.

3. The website browsing system according to claim 1, wherein
the second transmission device transmits information indicating the client terminal to the server;
the first receiving device receives the information indicating the client terminal; and
the session management device determines whether or not the client terminal is a mobile terminal on the basis of the information indicating the client terminal, and does not generate a session ID if it is determined that the client terminal is not a mobile terminal.

4. The website browsing system according to claim 1, wherein
the client terminal further comprises a user ID storage device in which information indicating a client terminal and a user ID are stored in association with each other,
the second transmission device transmits the information indicating the client terminal to the server,
the first receiving device receives the information indicating the client terminal, and
the session management device determines whether or not the received information indicating the client terminal is stored in the user ID storage device, and generates a session ID if it is determined that the information is stored in the user ID storage device.

5. The website browsing system according to claim 1, wherein
the client terminal comprises:
an execution device configured to execute the UI information on the image displayed on the display device; and
a rewriting device configured to rewrite the UI information metadata on the basis of the UI information executed by the execution device, and wherein
the second transmission device transmits the rewritten UI information metadata to the server together with the session ID,
the first receiving device receives the rewritten UI information metadata which has been transmitted from the client terminal together with the session ID,
the information generation device associated with the received session ID rewrites the image on the basis of the received UI information metadata, and
the first transmission device transmits the rewritten image to the client terminal together with the session ID.

6. The website browsing system according to claim 5, wherein
if the UI information executed by the execution device is UI information accompanied by screen transition, the second transmission device transmits information identifying the UI information to the server together with the session ID,
the first receiving device receives the information identifying the UI information and the session ID which have been transmitted from the second transmission device,
the information generation device associated with the received session ID generates an image of page contents to be displayed next and UI information metadata of the page contents on the basis of the received information, and
the first transmission device transmits the image of the page contents to be displayed next and the UI information metadata of the page contents which have been generated, to the client terminal.

7. The website browsing system according to claim 5, wherein
the execution device further comprises:
a movement device configured relatively to move a cursor and an image displayed on the display device; and
a decision device configured to decide UI information existing at a position overlapping a position of the cursor as UI information to be executed.

8. The website browsing system according to claim 7, wherein
the movement device moves the cursor relative to the image displayed on the display device.

9. The website browsing system according to claim 7, wherein
the movement device displays the cursor almost in the center of the display device and moves the image relative to the cursor.

10. The website browsing system according to claim 1, wherein
the movement device displays a visual effect on the basis of the UI information metadata.

11. The website browsing system according to claim 1, wherein
the server comprises a storage device in which page contents are stored; and
the first receiving device configured to acquire page contents acquires the page contents from the storage device.

12. The website browsing system according to claim 1, wherein
the server comprises a connecting device configured to connect to a web server; and
the first receiving device configured to acquire page contents acquires the page contents from the web server via the connecting device configured to connect to the web server.

13. A server constituting the website browsing system according to claim 1.
